(19) United States
(12) Patent Application Publication
(10) Pub. No.: US 2004/0128546 A1
(43) Pub. Date: Jul. 1, 2004

(54) Method and system for attribute exchange in a heterogeneous federated environment

(75) Inventors: George Robert Blakley III, Round Rock, TX (US); Heather Maria Hinton, Austin, TX (US); Anthony Joseph Nadalin, Austin, TX (US); Birgit Monika Pfitzmann, Samstagern (CH)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY

(21) Appl. No.: 10/334,539

(22) Filed: Dec. 31, 2002

(51) Int. Cl. H04L 9/00

(52) U.S. Cl. 713/201

(57) ABSTRACT

A system is presented for facilitating management of user attribute information at one or more attribute information providers (AIPs), which can manage the user's attribute information in accordance with user-selected or administratively-determined options, including options that are stored in attribute release policies and/or dynamically determined during a transaction. E-commerce service providers (ECSPs), such as online banks or merchants, may maintain a trust relationship with an AIP such that the ECSP can trust the user attribute information that is provided by the AIP on behalf of the user. The user can complete transactions that require user attribute information at any ECSP without having to have previously established a relationship with that particular ECSP. If the ECSP does not have a trust relationship with one of the user's AIPs, then the ECSP can rely upon a trust proxy to interpret and validate an attribute assertion that is received from an AIP.

### CROSS-REFERENCE TO RELATED APPLICATIONS

The present application is related to the following applications with a common assignee:

U.S. patent application Ser. No. ______ (Attorney Docket Number CH920020006), filed ______ (TBD), titled “Efficient browser-based identity management providing personal control and anonymity”;

U.S. patent application Ser. No. ______ (Attorney Docket Number AUS920020410US1), filed ______ 2002, titled “Method and System for Proof-of-Possession Operations Associated with Authentication Assertions in a Heterogeneous Federated Environment”;

U.S. patent application Ser. No. ______ (Attorney Docket Number AUS920020411US1), filed ______ 2002, titled “Local Architecture for Federated Heterogeneous System”;

U.S. patent application Ser. No. ______ (Attorney Docket Number AUS920020413US1), filed ______ 2002, titled “Method and System for Authentication in a Heterogeneous Federated Environment”;

U.S. patent application Ser. No. ______ (Attorney Docket Number AUS920020461US1), filed ______ 2002, titled “Method and System for Consolidated Sign-off in a Heterogeneous Federated Environment”;

U.S. patent application Ser. No. ______ (Attorney Docket Number AUS920020486US1), filed ______ 2002, titled “Method and System for Native Authentication Protocols in a Heterogeneous Federated Environment”;

U.S. patent application Ser. No. ______ (Attorney Docket Number AUS9-2000-0770-US1), filed Nov. 9, 2000, titled “Method and system for Web-based cross-domain single-sign-on authentication”;

U.S. patent application Ser. No. ______ (Attorney Docket Number AUS920010769US1), filed ______ (TBD), titled “System and method for user enrollment in an e-community”;

U.S. patent application Ser. No. ______ (Attorney Docket Number AUS920020386US1), filed ______ (TBD), titled “Method and system for user-determined authentication in a federated environment”;

U.S. patent application Ser. No. ______ (Attorney Docket Number AUS920020435US1), filed ______ (TBD), titled “Method and system for user-determined attribute storage in a federated environment”; and

U.S. patent application Ser. No. ______ (Attorney Docket Number AUS920020726US1), filed ______ (TBD), titled “Method and system for enroll-thru operations and reprioritization operations in a federated environment”.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for distributed data storage and data transfer of user information.

2. Description of Related Art

The Internet has greatly facilitated the exchange of information for many purposes. Many applications have incorporated Internet-related standards, thereby enabling organizations to collaborate over the Internet while maintaining private networks. As Internet-connected applications have become more sophisticated, organizations have shown a desire to increase the level of collaboration, particularly within so-called federated environments.

In a federated environment, each user is typically registered in a home domain that provides certain fundamental services to a user. When a user logs into the user's home domain through some form of authentication process, the user is allowed to access secured resources that are supported by the home domain in accordance with the user's previously defined authorization attributes. In this manner, the user has a permanent relationship with the user's home domain.

In addition, the home domain may have a permanent relationship with many other domains in a federation or a federated environment, sometimes also called business-to-business (B2B) or e-community domains. A federation may or may not require explicit business relationships between pairwise sets of participating enterprises. Each domain or organization within a federated environment may share resources to some extent with users in other domains or organizations within the federated environment.

As users become more knowledgeable about the Internet, they expect enterprises to collaborate so that burdens on the user are reduced. These expectations also apply to management of informational characteristics about a user, sometimes referred to as user attributes. In some circumstances and under certain restrictions, a user might assume that once he or she has provided some user information to one computer system, the user information might be available throughout the user's current session without regard to the various computer boundaries that are sometimes invisible to the user. Enterprises generally try to fulfill these expectations in the operational characteristics of their deployed systems, not only to placate users but also to increase user efficiency, whether the user efficiency is related to employee productivity or customer satisfaction.

More specifically, with the current computing environment in which many applications use Web-based user interfaces that are accessible through a common browser, users expect more user-friendliness and low or infrequent barriers to movement from one Web-based application to another. In this context, users are coming to expect the ability to jump from interacting with an application on one Internet domain to another application on another domain with minimal regard to the information barriers between each particular domain. Even if many systems provide easy-to-use Web-based interfaces, though, a user may still be forced to reckon with multiple user information requests or requirements that stymie user movement across a set of domains. Subjecting a user to multiple information requests or requirements in a short time frame significantly affects the user's efficiency.

Most systems that manage user attributes were designed to work within a single enterprise rather than in a federated environment of organizations which are loosely coupled. Hence, the barriers that are presented by user information requests or requirements are becoming increasingly common as more organizations participate in federated computing environments.

As mentioned above, within a federated environment, a user that is a registered member of one organization can get access to a remote resource that is controlled by another organization; each organization is responsible for the administration of the organization's own registered users and resources, yet the computer systems of the federated organizations interoperate in some manner to share resources between registered members of the organizations. These systems have not offered significant user-level control over the extent to which user attributes are released to, or shared with, other organizations. However, privacy laws require that some organizations allow users to control the personally identifiable information that is released by an organization and to whom it is released. The demand for more privacy laws has increased as users have learned the ways in which private information can be abused.

Therefore, it would be advantageous to provide a method for user-level control over the storage, management, and distribution of user attributes within a federated environment while minimizing user inconvenience and/or information barriers between federated organizations.

### SUMMARY OF THE INVENTION

A method, apparatus, system, or computer program product is presented for facilitating management of user attribute information at one or more attribute information providers. Attribute information providers can manage a user's attribute information in accordance with user-selected or administratively-determined options, including options that are stored in attribute release policies and/or dynamically determined during a transaction. The user can complete transactions that require user attribute information at any e-commerce service provider without having to have previously established a relationship with that particular e-commerce service provider.

An e-commerce service provider, such as an online bank or online merchant, may maintain a relationship with an attribute information provider such that the e-commerce service provider can trust the user attribute information that is provided by the attribute information provider on behalf of the user. An e-commerce service provider allows a specification of one or more attribute information providers to be used by the e-commerce service provider to retrieve user attribute information for a user. The e-commerce service provider may receive a specification of an attribute information provider, e.g., in the form of an HTTP cookie, along with the request for access to a resource. If the e-commerce service provider has a relationship with one of the user's attribute information providers, then the user will be able to direct the e-commerce service provider to an attribute information provider when the e-commerce service provider needs user attribute information to complete a transaction for the user. The user attribute information is used by the e-commerce service provider in performing a user-specific operation with respect to a requested resource, such as determining whether the user should be granted access to the resource or for personalization purposes. The e-commerce service provider may retrieve user attributes from multiple prioritized attribute information providers.

Trust proxies allow the pre-existing security services in a given domain to establish trust relationships with other domains without having to subscribe to the same trust root or use the same trust-establishment technology. Each domain is free to accept, reject, or modify any other domain's statements about user identity and attributes. A relying domain relies on an issuing domain's (ultimately, a home domain's) assertions of identity and attributes, yet each domain can implement any authentication protocol, and the applications within a given domain do not need to be modified to implement a previously unsupported protocol in order for the domain to participate in the federation. The federation does not require a particular trust model; a set of entities can form a federation that conforms to the trust model that the participating entities may have already established. Assertion translations occur only at the trust proxies and/or the trust brokers; the federation architecture acts as a front-end infrastructure that can be implemented with minimal impact on an existing legacy system.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 1C depicts a data flow diagram that illustrates a typical authentication process that may be used when a client attempts to access a protected resource at a server;

FIG. 1D depicts a network diagram that illustrates a typical Web-based environment in which the present invention may be implemented;

FIG. 1E depicts a block diagram that illustrates an example of a typical online transaction that might require multiple authentication operations from a user;

FIG. 2A depicts a block diagram that illustrates the terminology of the federated environment with respect to a transaction that is initiated by a user to a first federated enterprise, which, in response, invokes actions at downstream entities within the federated environment;

FIG. 2B depicts a block diagram that illustrates the integration of pre-existing systems at a given domain with some of the federated architecture components of the present invention in accordance with an embodiment of the present invention;

FIG. 2C depicts a block diagram that illustrates a federated architecture in accordance with an implementation of the present invention;

FIG. 2D depicts a block diagram that illustrates an exemplary set of trust relationships between federated domains using trust proxies and a trust broker in accordance with the present invention;

FIG. 3A depicts a flowchart that illustrates a generalized process at an issuing domain for creating an assertion within a federated environment;

FIG. 3B depicts a flowchart that illustrates a generalized process at a relying domain for tearing down an assertion;

FIG. 3C depicts a flowchart that illustrates a specific process for pushing an assertion from an issuing domain to a relying domain in response to a user action at the issuing domain;

FIG. 3D depicts a flowchart that illustrates a specific process for pushing an assertion from an issuing domain to a relying domain in response to the issuing domain actively intercepting an outgoing request to the relying domain;

FIG. 3E depicts a flowchart that illustrates a pull model in which a relying domain requests any required assertions for a user from an issuing domain while attempting to satisfy a resource request that was received by the relying domain from the requesting user;

FIG. 4 depicts a block diagram that illustrates a federated environment that supports federated single-sign-on operations;

FIG. 5A is a block diagram that depicts an example of a typical online transaction that requires user attributes;

FIG. 5B is a block diagram that depicts a typical federated computing environment;

FIG. 5C is a block diagram that depicts a preferred federated environment in which the present invention may be implemented;

FIG. 6 is a flowchart that depicts a process by which an e-commerce service provider attempts to retrieve attribute information from an attribute information provider for a user who is attempting to access a resource at the e-commerce service provider;

FIG. 7 is a flowchart that depicts a subprocess by which an e-commerce service provider attempts to retrieve attribute information from multiple prioritized attribute information providers for a user who is attempting to access a resource at the e-commerce service provider;

FIGS. 8A-8C contain a set of flowcharts that depicts a process by which an attribute information provider determines whether or not it can or should provide attribute information for a user at the request of an e-commerce service provider;

FIGS. 8D-8E contain a set of flowcharts that depict a process by which an attribute information provider generates a response message to be sent to an e-commerce service provider that has requested the retrieval of attributes for a particular user;

FIG. 9A is a graphical user interface window that is presented to a user by an attribute information provider that is requesting the user to input user attribute information that will be used by an e-commerce service provider within a federated environment;

FIG. 9B is a graphical user interface window that is presented to a user by an attribute information provider that is requesting the user to release user attribute information that will be used by an e-commerce service provider within a federated environment;

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

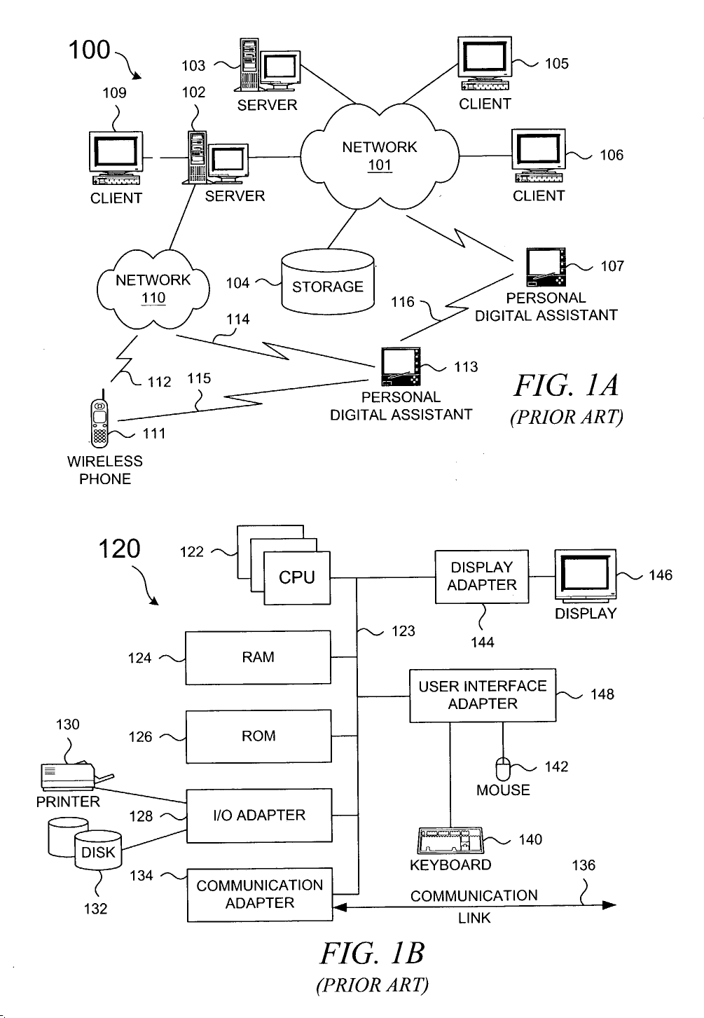

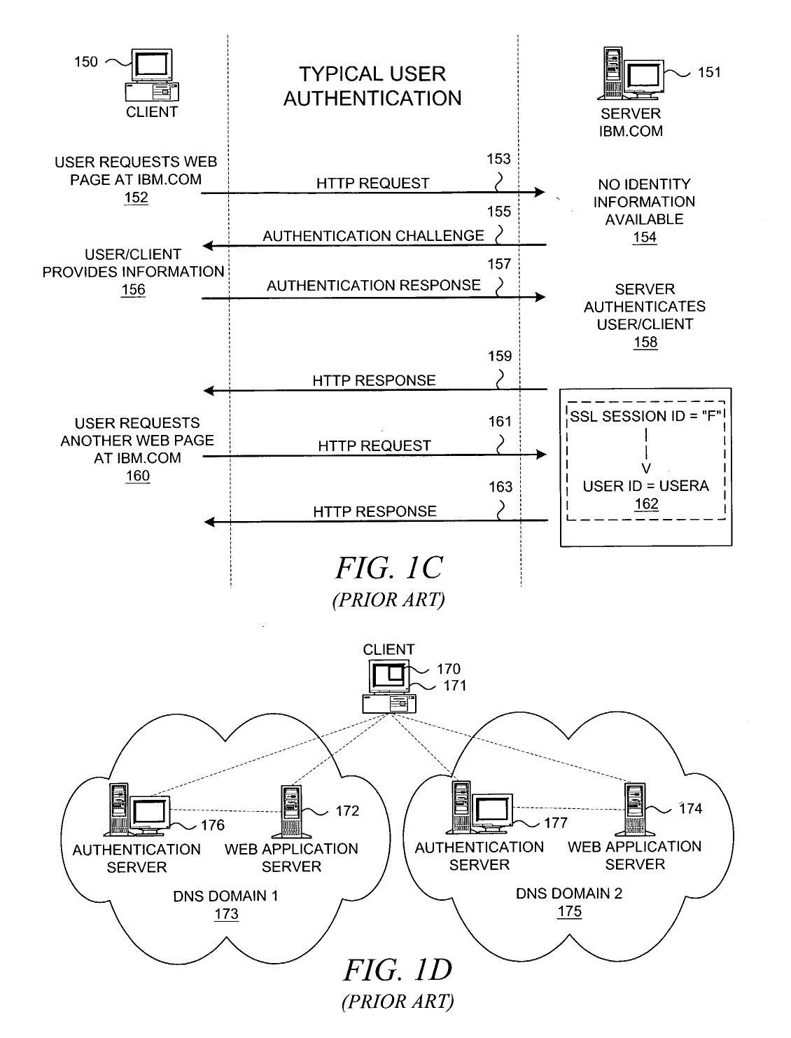

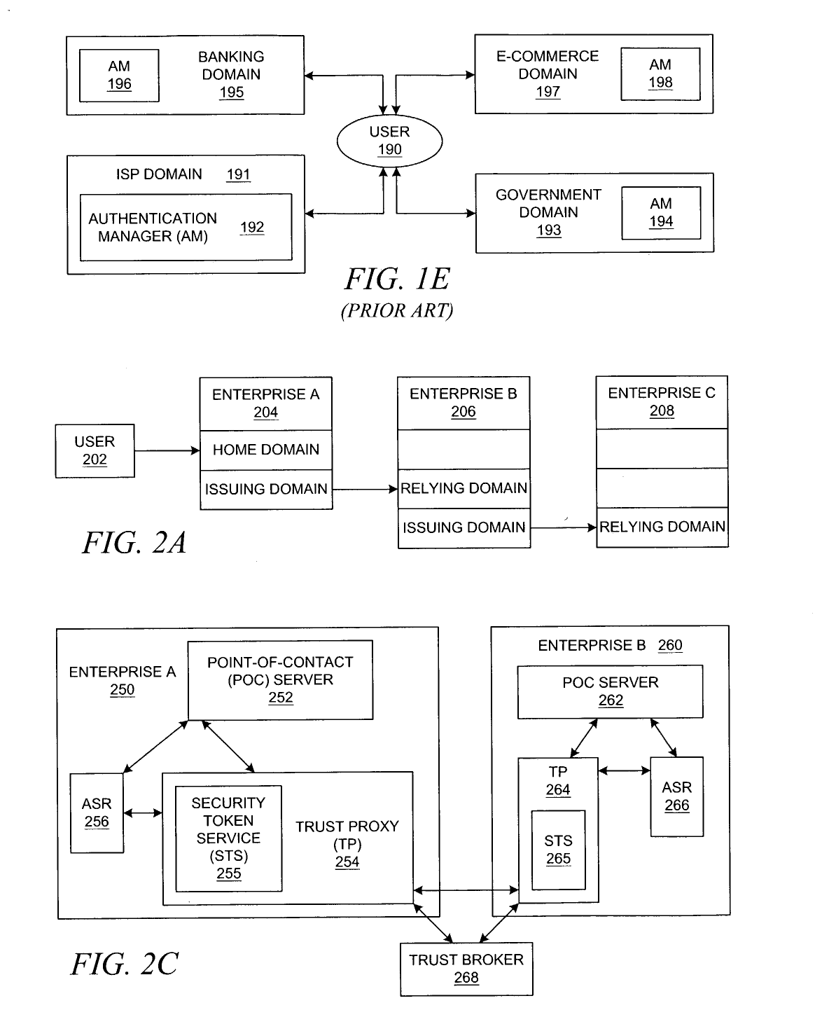

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as LDAP (Lightweight Directory Access Protocol), TCP/IP (Transport Control Protocol/Internet Protocol), HTTP (HyperText Transport Protocol), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116.

The present invention could be implemented on a variety of hardware platforms and software environments. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. It should also be noted that the distributed data processing system shown in FIG. 1A is contemplated as being fully able to support a variety of peer-to-peer subnets and peer-to-peer services.

With reference now to FIG. 1C, a data flow diagram illustrates a typical authentication process that may be used when a client attempts to access a protected resource at a server. As illustrated, the user at a client workstation 150 seeks access over a computer network to a protected resource on a server 151 through the user's Web browser executing on the client workstation. A protected resource is identified by a Uniform Resource Locator (URL), or more generally, a Uniform Resource Identifier (URI), that can only be accessed by an authenticated and authorized user. The computer network may be the Internet, an intranet, or other network, as shown in FIG. 1A or FIG. 1B, and server may be a Web Application Server (WAS), a server application, a servlet process, or the like.

The process is initiated when the user requests the protected resource, such as a Web page within the domain “ibm.com” (step 152). The Web browser (or associated application or applet) generates an HTTP request message that is sent to the Web server that is hosting the domain “ibm.com” (step 153). The server determines that it does not have an active session for the client (step 154), so the server requires the user to perform an authentication process by sending the client some type of authentication challenge (step 155). The authentication challenge may be in various formats, such as a Hypertext Markup Language (HTML) form. The user then provides the requested or required information (step 156), such as a user identifier and an associated password, or the client may automatically return certain information.

The authentication response information is sent to the server (step 157), at which point the server authenticates the user or client (step 158), e.g., by retrieving previously submitted registration information and matching the presented authentication information with the user's stored information. Assuming the authentication is successful, an active session is established for the authenticated user or client.

The server then retrieves the requested Web page and sends an HTTP response message to the client (step 159). At that point, the user may request another page within “ibm.com” (step 160) within the browser by clicking a hypertext link, and the browser sends another HTTP Request to the server (step 161). At that point, the server recognizes that the user has an active session (step 162), and the server sends the requested Web page back to the client in another HTTP response message (step 163). Although FIG. 1C depicts a typical prior art process, it should be noted that other alternative session state management techniques may be depicted, such as using cookies to identify users with active sessions, which may include using the same cookie that is used to provide proof of authentication.

With reference now to FIG. 1D, a network diagram illustrates a typical Web-based environment in which the present invention may be implemented. In this environment, a user of a browser 170 at client 171 desires to access a protected resource on web application server 172 in DNS domain 173, or on web application server 174 in DNS domain 175.

In a manner similar to that shown in FIG. 1C, a user can request a protected resource at one of many domains. In contrast to FIG. 1C, which shows only a single server at a particular domain, each domain in FIG. 1D has multiple servers. In particular, each domain may have an associated authentication server 176 and 177.

In this example, after client 171 issues a request for a protected resource at domain 173, web application server 172 determines that it does not have an active session for client 171, and it requests that authentication server 176 perform an appropriate authentication operation with client 171. Authentication server 176 communicates the result of the authentication operation to web application server 172. If the user (or browser 170 or client 171 on behalf of the user) is successfully authenticated, then web application server 172 establishes a session for client 171 and returns the requested protected resource. Typically, once the user is authenticated by the authentication server, a cookie may be set and stored in a cookie cache in the browser. FIG. 1D is merely an example of one manner in which the processing resources of a domain may be shared amongst multiple servers, particularly to perform authentication operations.

In a similar manner, after client 171 issues a request for a protected resource at domain 175, authentication server 177 performs an appropriate authentication operation with client 171, after which web application server 174 establishes a session for client 171 and returns the requested protected resource. Hence, FIG. 1D illustrates that client 171 may have multiple concurrent sessions in different domains yet is required to complete multiple authentication operations to establish those concurrent sessions.

With reference now to FIG. 1E, a block diagram depicts an example of a typical online transaction that might require multiple authentication operations from a user. Referring again to FIG. 1C and FIG. 1D, a user may be required to complete an authentication operation prior to gaining access to a controlled resource, as shown in FIG. 1C. Although not shown in FIG. 1C, an authentication manager may be deployed on server 151 to retrieve and employ user information that is required to authenticate a user. As shown in FIG. 1D, a user may have multiple current sessions within different domains 173 and 175, and although they are not shown in FIG. 1D, each domain may employ an authentication manager in place of or in addition to the authentication servers. In a similar manner, FIG. 1E also depicts a set of domains, each of which support some type of authentication manager. FIG. 1E illustrates some of the difficulties that a user may experience when accessing multiple domains that require the user to complete an authentication operation for each domain.

User 190 may be registered at ISP domain 191, which may support authentication manager 192 that authenticates user 190 for the purpose of completing transactions with respect to domain 191. ISP domain 191 may be an Internet Service Provider (ISP) that provides Internet connection services, email services, and possibly other e-commerce services. Alternatively, ISP domain 191 may be an Internet portal that is frequently accessed by user 190.

Similarly, domains 193, 195, and 197 represent typical web service providers. Government domain 193 supports authentication manager 194 that authenticates users for completing various government-related-transactions. Banking domain 195 supports authentication manager 196 that authenticates users for completing transactions with an online bank. E-commerce domain 197 supports authentication manager 198 that authenticates users for completing online purchases.

As noted previously, when a user attempts to move from one domain to another domain within the Internet or World Wide Web by accessing resources at the different domains, a user may be subjected to multiple user authentication requests or requirements, which can significantly slow the user's progress across a set of domains. Using FIG. 1E as an exemplary environment, user 190 may be involved in a complicated online transaction with e-commerce domain 197 in which the user is attempting to purchase an on-line service that is limited to users who are at least 18 years old and who have a valid driver license, a valid credit card, and a U.S. bank account. This online transaction may involve domains 191, 193, 195, and 197.

Typically, a user might not maintain an identity within each domain that participates in a typical online transaction. In this example, user 190 may have registered his or her identity with the user's ISP, but to complete the online transaction, the user might also be required to authenticate to domains 193, 195, and 197. If each of the domains does not maintain an identity for the user, then the user's online transaction may fail. Even if the user can be authenticated by each domain, then it is not guaranteed that the different domains can transfer information between themselves in order to complete the user's transaction. For user 190 shown in FIG. 1E, there is no prior art environment that allows user 190 to authenticate to a first web site, e.g., ISP 191, and then transfer an authentication token to other web service providers, such as domains 193, 195, and 197, for single-sign-on purposes.

Given the preceding brief description of some current technology, the description of the remaining figures relates to federated computer environments in which the present invention may operate. Prior to discussing the present invention in more detail, however, some terminology is introduced.

Terminology

The terms “entity” or “party” generally refers to an organization, an individual, or a system that operates on behalf of an organization, an individual, or another system. The term “domain” connotes additional characteristics within a network environment, but the terms “entity”, “party”, and “domain” can be used interchangeably. For example, the term “domain” may also refer to a DNS (Domain Name System) domain, or more generally, to a data processing system that includes various devices and applications that appear as a logical unit to exterior entities.

The terms “request” and “response” should be understood to comprise data formatting that is appropriate for the transfer of information that is involved in a particular operation, such as messages, communication protocol information, or other associated information. A protected resource is a resource (an application, an object, a document, a page, a file, executable code, or other computational resource, communication-type resource, etc.) for which access is controlled or restricted.

A token provides direct evidence of a successful operation and is produced by the entity that performs the operation, e.g., an authentication token that is generated after a successful authentication operation. A Kerberos token is one example of an authentication token that may be used in the present invention. More information on Kerberos may be found in Kohl et al., “The Kerberos Network Authentication Service (V5)”, Internet Engineering Task Force (IETF) Request for Comments (RFC) 1510, September 1993.

An assertion provides indirect evidence of some action. Assertions may provide indirect evidence of identity, authentication, attributes, authorization decisions, or other information and/or operations. An authentication assertion provides indirect evidence of authentication by an entity that is not the authentication service but that listened to the authentication service.

A Security Assertion Markup Language (SAML) assertion is an example of a possible assertion format that may be used within the present invention. SAML has been promulgated by the Organization for the Advancement of Structured Information Standards (OASIS), which is a non-profit, global consortium. SAML is described in “Assertions and Protocol for the OASIS Security Assertion Markup Language (SAML)”, Committee Specification 01, May 31, 2002, as follows:

The Security Assertion Markup Language (SAML) is an XML-based framework for exchanging security information. This security information is expressed in the form of assertions about subjects, where a subject is an entity (either human or computer) that has an identity in some security domain. A typical example of a subject is a person, identified by his or her email address in a particular Internet DNS domain. Assertions can convey information about authentication acts performed by subjects, attributes of subjects, and authorization decisions about whether subjects are allowed to access certain resources. Assertions are represented as XML constructs and have a nested structure, whereby a single assertion might contain several different internal statements about authentication, authorization, and attributes. Note that assertions containing authentication statements merely describe acts of authentication that happened previously. Assertions are issued by SAML authorities, namely, authentication authorities, attribute authorities, and policy decision points. SAML defines a protocol by which clients can request assertions from SAML authorities and get a response from them. This protocol, consisting of XML-based request and response message formats, can be bound to many different underlying communications and transport protocols; SAML currently defines one binding, to SOAP over HTTP. SAML authorities can use various sources of information, such as external policy stores and assertions that were received as input in requests, in creating their responses. Thus, while clients always consume assertions, SAML authorities can be both producers and consumers of assertions.

The SAML specification states that an assertion is a package of information that supplies one or more statements made by an issuer. SAML allows issuers to make three different kinds of assertion statements: authentication, in which the specified subject was authenticated by a particular means at a particular time; authorization, in which a request to allow the specified subject to access the specified resource has been granted or denied; and attribute, in which the specified subject is associated with the supplied attributes. As discussed further below, various assertion formats can be translated to other assertion formats when necessary.

Authentication is the process of validating a set of credentials that are provided by a user or on behalf of a user. Authentication is accomplished by verifying something that a user knows, something that a user has, or something that the user is, i.e. some physical characteristic about the user. Something that a user knows may include a shared secret, such as a user's password, or by verifying something that is known only to a particular user, such as a user's cryptographic key. Something that a user has may include a smartcard or hardware token. Some physical characteristic about the user might include a biometric input, such as a fingerprint or a retinal map.

An authentication credential is a set of challenge/response information that is used in various authentication protocols. For example, a username and password combination is the most familiar form of authentication credentials. Other forms of authentication credential may include various forms of challenge/response information, Public Key Infrastructure (PKI) certificates, smartcards, biometrics, etc. An authentication credential is differentiated from an authentication assertion: an authentication credential is presented by a user as part of an authentication protocol sequence with an authentication server or service, and an authentication assertion is a statement about the successful presentation and validation of a user's authentication credentials, subsequently transferred between entities when necessary.

Distinguishing Prior-Art Single-Sign-On Solutions

As noted above, prior-art single-sign-on solutions are limited to homogeneous environments in which there are pre-established business agreements between participating enterprises. These business agreements establish trust and define secure transfers of information between enterprises. These business agreements also include technological agreements on rules on how to translate, or map, user identities from one enterprise to another, and how to transfer the information used to vouch for users between participating enterprises.

In other words, previous single-sign-on solutions allow one enterprise to trust an authentication assertion (along with the identity of the user provided in the assertion) produced by a different enterprise based on the pre-negotiated or pre-configured agreements. Each distinct enterprise knows how to create and interpret authentication assertions that can be understood by other enterprises that have exchanged similar agreements, such as enterprises within an e-commerce marketplace. These homogeneous environments are tightly coupled because there is a deterministic relationship known by the enterprises for mapping the user identities across these systems. This tight coupling is possible because of the business agreements that are used to establish the single-sign-on environment.

Federation Model of Present Invention

In the context of the World Wide Web, users are coming to expect the ability to jump from interacting with an application on one Internet domain to another application on another domain with minimal regard to the information barriers between each particular domain. Users do not want the frustration that is caused by having to authenticate to multiple domains for a single transaction. In other words, users expect that organizations should interoperate, but users generally want domains to respect their privacy. In addition, users may prefer to limit the domains that permanently store private information. These user expectations exist in a rapidly evolving heterogeneous environment in which many enterprises and organizations are promulgating competing authentication techniques.

In contrast to prior-art systems, the present invention provides a federation model for allowing enterprises to provide a single-sign-on experience to a user in the absence of specific, pre-established, business and technical agreements between particular enterprises. In other words, the present invention supports a federated, heterogeneous environment. As an example of an object of the present invention, referring again to FIG. 1E, user 190 is able to authenticate to domain 191 and then have domain 191 provide the appropriate assertions to each downstream domain that might be involved in a transaction. These downstream domains need to be able to understand and trust authentication assertions and/or other types of assertions, even though there are no pre-established assertion formats between domain 191 and these other downstream domains. In addition to recognizing the assertions, the downstream domains need to be able to translate the identity contained within an assertion to an identity that represents user 190 within a particular domain, even though there is no pre-established identity mapping relationship.

The present invention is directed to a federated environment. In general, an enterprise has its own user registry and maintains relationships with its own set of users. Each enterprise typically has its own means of authenticating these users. However, the federated scheme of the present invention allows enterprises to cooperate in a collective manner such that users in one enterprise can leverage relationships with a set of enterprises through an enterprise's participation in a federation of enterprises. Users can be granted access to resources at any of the federated enterprises as if they had a direct relationship with each enterprise. Users are not required to register at each business of interest, and users are not constantly required to identify and authenticate themselves. Hence, within this federated environment, an authentication scheme allows for a single-sign-on experience within the rapidly evolving heterogeneous environments in information technology.

In the present invention, a federation is a set of distinct entities, such as enterprises, organizations, institutions, etc., that cooperate to provide a single-sign-on, ease-of-use experience to a user. In the present invention, a federated environment differs from a typical single-sign-on environment in that two enterprises need not have a direct, pre-established, relationship defining how and what information to transfer about a user. Within a federated environment, entities provide services which deal with authenticating users, accepting authentication assertions, e.g., authentication tokens, that are presented by other entities, and providing some form of translation of the identity of the vouched-for user into one that is understood within the local entity.

Federation eases the administrative burden on service providers. A service provider can rely on its trust relationship with respect to the federation as a whole; the service provider does not need to manage authentication information, such as user password information, because it can rely on authentication that is accomplished by a user's authentication home domain.

The present invention also concerns a federated identity management system that establishes a foundation in which loosely coupled authentication, user enrollment, user profile management and/or authorization services, collaborate across security domains. Federated identity management allows services residing in disparate security domains to securely interoperate and collaborate even though there may be differences in the underlying security mechanisms and operating system platforms at these disparate domains. A single-sign-on experience is established once a user establishes their participation in a federation.

Home Domain, Issuing Party, and Relying Party

As explained in more detail further below, the present invention provides significant user benefits. The present invention allows a user to authenticate at a first entity, hereinbelow also referred to as the user's home domain or authentication home domain. This first entity may act as an issuing party, which issues an authentication assertion about the user for use at a second entity. The user can then access protected resources at a second, distinct entity, termed the relying party, by presenting the authentication assertion that was issued by the first entity without having to explicitly re-authenticate at the second entity. Information that is passed from an issuing party to a relying party is in the form of an assertion, and this assertion may contain different types of information in the form of statements. For example, an assertion may be a statement about the authenticated identity of a user, or it may be a statement about user attribute information that is associated with a particular user.

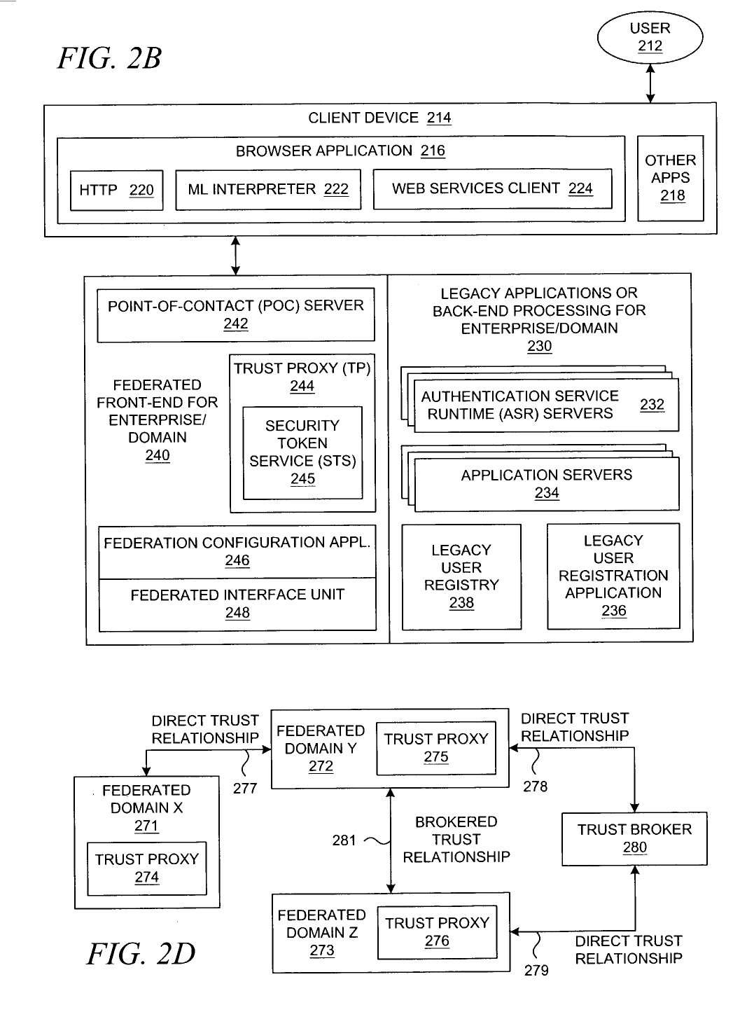

With reference now to FIG. 2A, a block diagram depicts the terminology of the federated environment with respect to a transaction that is initiated by a user to a first federated enterprise, which, in response, invokes actions at downstream entities within the federated environment. FIG. 2A shows that the terminology may differ depending on the perspective of an entity within the federation for a given federated operation. User 202 initiates a transaction through a request for a protected resource at enterprise 204. If user 202 has been authenticated by enterprise 204, then enterprise 204 is the user's home domain for this federated session. Assuming that the transaction requires some type of operation by enterprise 206 and enterprise 204 transfers an assertion to enterprise 206, then enterprise 204 is the issuing domain with respect to the particular operation, and enterprise 206 is the relying domain for the operation. Assuming that the transaction requires further operations and enterprise 206 transfers an assertion to enterprise 208, then enterprise 206 is the issuing domain with respect to the requested operation, and enterprise 208 is the relying domain for the operation.

In the federated environment of the present invention, the domain at which the user authenticates is termed the user's (authentication) home domain. The home domain maintains authentication credentials. The home domain may be the user's employer, the user's ISP, or some other service provider. It is possible that there may be multiple enterprises within a federated environment that could act as a user's home domain because there may be multiple enterprises that have the ability to generate and validate a user's authentication credentials.

From an authentication perspective, an issuing party for an authentication assertion is usually the user's authentication home domain. The user's home domain may or may not maintain personal information or profile information for the user. Hence, from an attribute perspective involving personally identifiable information, personalization information, or other user attributes, an issuing party for an attribute assertion may or may not be the user's authentication home domain, To avoid any confusion, separate terminology can be employed for attribute home domains and authentication home domains, but the term “home domain” hereinbelow may be interpreted as referring to an authentication home domain.

Within the scope of a given federated session, however, there is usually one and only one domain that acts as the user's home domain. Once a user has authenticated to this domain, all other domains or enterprises in the federation are treated as relying parties for the duration of that session.

Given that the present invention provides a federated infrastructure that can be added to existing systems while minimizing the impact on an existing, non-federated architecture, authentication at a user's home domain is not altered by the fact that the home domain may also participate within a federated environment. In other words, even though the home domain may be integrated into a federated environment that is implemented in accordance with the present invention, the user should have the same end-user experience while performing an authentication operation at the user's home domain. It should be noted, though, that not all of a given enterprise's users will necessarily participate in the federated environment.

Moreover, user registration, e.g., establishment of a user account, is not altered by the fact that the home domain may also participate within a federated environment. A user establishes an account at a domain through a registration process that is independent of a federated environment. In other words, the establishment of a user account at a home domain does not include the establishment of account information that is valid across a federation, e.g., identity translation information. If there is a single federated domain that is able to authenticate a user, i.e. there is one and only one domain within the federation with whom the user has registered, then this domain will always act as the user's home domain and may direct the user's movement throughout the federated environment.

If a user has multiple possible home domains within a federated environment, then a user may enter the federation via more than one entry point. In other words, the user may have accounts at multiple domains, and these domains do not necessarily have information about the other domains nor about a user's identity at the other domains.

While the domain at which the user authenticates is termed the home domain, the issuing domain is a federation entity that issues an assertion for use by another domain, i.e. the relying domain. An issuing domain is usually, but not necessarily, the user's home domain. Hence, it would usually be the case that the issuing party has authenticated the user through typical authentication protocols, as mentioned above. However, it is possible that the issuing party has previously acted as a relying party whereby it received an assertion from a different issuing party. In other words, since a user-initiated transaction may cascade through a series of enterprises within a federated environment, a receiving party may subsequently act as an issuing party for a downstream transaction. In general, any domain that has the ability to issue authentication assertions on behalf of a user can act as an issuing domain.

The relying domain is a domain that receives an assertion from an issuing party. The relying party is able to accept, trust, and understand an assertion that is issued by a third party on behalf of the user, i.e. the issuing domain. It is generally the relying party's duty to use an appropriate authentication authority to interpret an authentication assertion. In addition, it is possible that the relying party is able to authenticate a particular user, i.e. to act as a user's home domain, but it is also possible that a relying party may not be able to authenticate a particular user through conventional methods. Hence, a relying party is a domain or an enterprise that relies on the authentication assertion that is presented by a user and that provides a user with a single-sign-on experience instead of prompting the user for the user's authentication credentials as part of an interactive session with the user.

Federated Architecture—Federated Front-End for Legacy Systems

With reference now to FIG. 2B, a block diagram depicts the integration of pre-existing systems at a given domain with some of the federated architecture components of the present invention in accordance with an embodiment of the present invention. A federated environment includes federated entities that provide a variety of services for users. User 212 interacts with client device 214, which may support browser application 216 and various other client applications 218. User 212 is distinct from client device 214, browser 216, or any other software that acts as interface between user and other devices and services. In some cases, the following description may make a distinction between the user acting explicitly within a client application and a client application that is acting on behalf of the user. In general, though, a requester is an intermediary, such as a client-based application, browser, SOAP client, etc., that may be assumed to act on behalf of the user.

Browser application 216 may be a typical browser that comprises many modules, such as HTTP communication component 220 and markup language (ML) interpreter 222. Browser application 216 may also support plug-ins, such as web services client 224, and/or downloadable applets, which may or may not require a virtual machine runtime environment. Web services client 224 may use Simple Object Access Protocol (SOAP), which is a lightweight protocol for defining the exchange of structured and typed information in a decentralized, distributed environment. SOAP is an XML-based protocol that consists of three parts: an envelope that defines a framework for describing what is in a message and how to process it; a set of encoding rules for expressing instances of application-defined datatypes; and a convention for representing remote procedure calls and responses. User 212 may access web-based services using browser application 216, but user 212 may also access web services through other web service clients on client device 214. Some of the examples of the present invention that are shown in the following figures employ HTTP redirection via the user's browser to exchange information between entities in a federated environment. However, it should be noted that the present invention may be conducted over a variety of communication protocols and is not meant to be limited to HTTP-based communications. For example, the entities in the federated environment may communicate directly when necessary; messages are not required to be redirected through the user's browser.

The present invention may be implemented in a manner such that components that are required for a federated environment can be integrated with pre-existing systems. FIG. 2B depicts one embodiment for implementing these components as a front-end to a pre-existing system. The pre-existing components at a federated domain can be considered as legacy applications or back-end processing components 230, which include authentication service runtime (ASR) servers 232 in a manner similar to that shown in FIG. 2C. ASR servers 232 are responsible for authenticating users when the domain controls access to application servers 234, which can be considered to generate, retrieve, or otherwise process protected resources. The domain may continue to use legacy user registration application 236 to register users for access to application servers 234. Information that is needed to authenticate a registered user is stored in legacy user registry 238.

After joining a federated environment, the domain may continue to operate without the intervention of federated components. In other words, the domain may be configured so that users may continue to access particular application servers or other protected resources directly without going through a point-of-contact server or other component implementing this point-of-contact server functionality; a user that accesses a system in this manner would experience typical authentication flows and typical access. In doing so, however, a user that directly accesses the legacy system would not be able to establish a federated session that is known to the domain's point-of-contact server.

The domain's legacy functionality can be integrated into a federated environment through the use of federated front-end processing 240, which includes point-of-contact server 242 and trust proxy server 244 (or more simply, trust proxy 244) which itself includes Security Token Service (STS) 245, all of which are described in more detail below with respect to FIG. 2C. Federation configuration application 246 allows an administrative user to configure the federated front-end components to allow them to interface with the legacy back-end components through federated interface unit 248.

Legacy or pre-existing authentication services at a given enterprise may use various, well known, authentication methods or tokens, such as username/password or smart card token-based information. However, with the present invention, the functionality of a legacy authentication service can be used in a federated environment through the use of point-of-contact servers. Users may continue to access a legacy authentication server directly without going through a point-of-contact server, although a user that accesses a system in this manner would experience typical authentication flows and typical access; a user that directly accesses a legacy authentication system would not be able to generate a federated authentication assertion as proof of identity in accordance with the present invention. One of, the roles of the federated front-end is to translate a federated authentication token received at a point-of-contact server into a format understood by a legacy authentication service. Hence, a user accessing the federated environment via the point-of-contact server would not necessarily be required to re-authenticate to the legacy authentication service. Preferably, the user would be authenticated to a legacy authentication service by a combination of the point-of-contact server and a trust proxy such that it appears as if the user was engaged in an authentication dialog.

Federated Architecture—Point-of-Contact Servers, Trust Proxies, and Trust Brokers

With reference now to FIG. 2C, a block diagram depicts a federated architecture in accordance with an implementation of the present invention. A federated environment includes federated enterprises or similar entities that provide a variety of services for users. A user, through an application on a client device, may attempt to access resources at various entities, such as enterprise 250. A point-of-contact server at each federated enterprise, such as point-of-contact (POC) server 252 at enterprise 250, is the user's entry point into the federated environment. The point-of-contact server minimizes the impact on existing components within an existing, non-federated architecture, e.g., legacy systems, because the point-of-contact server handles many of the federation requirements. The point-of-contact server provides session management, protocol conversion, and possibly initiates authentication assertion conversion. For example, the point-of-contact server may translate HTTP or HTTPS messages to SOAP and vice versa. As explained in more detail further below, the point-of-contact server may also be used to invoke a trust proxy to translate authentication assertions, e.g., a SAML token received from an issuing party can be translated into a Kerberos token understood by a receiving party.

A trust proxy or a trust proxy server, such as trust proxy (TP) 254 at enterprise 250, establishes and maintains a trust relationship between two entities in a federation. A trust proxy generally has the ability to handle authentication token format translation (through the security token service, which is described in more detail further below) from a format used by the issuing party to one understood by the receiving party.

Together, the use of a point-of-contact server and a trust proxy minimize the impact of implementing a federated architecture on an existing, non-federated set of systems. Hence, the federated architecture of the present invention requires the implementation of at least one point-of-contact server and at least one trust proxy per federated entity, whether the entity is an enterprise, a domain, or other logical or physical entity. The federated architecture of the present invention, though, does not necessarily require any changes to the existing, non-federated set of systems. Preferably, there is a single trust proxy for a given federated entity, but there may be multiple trust proxies for availability purposes, or there may be multiple trust proxies for a variety of smaller entities within a federated entity, e.g., separate subsidiaries within an enterprise. It is possible that a given entity could belong to more than one federation, although this scenario would not necessarily require multiple trust proxies as a single trust proxy could manage trust relationships within multiple federations.

One role of a trust proxy is to determine the required token type by another domain and/or the trust proxy in that domain. A trust proxy has the ability to handle authentication token format translation from a format used by the issuing party to one understood by the receiving party. Trust proxy 254 is also responsible for any user identity translation or attribute translation that occurs for enterprise 250. However, a trust proxy may invoke a trust broker for assistance, as described further below. Identity translation may be required to map a user's identity and attributes as known to an issuing party to one that is meaningful to a receiving party. This translation may be invoked by either a trust proxy at an issuing domain or a trust proxy at a receiving domain.

Trust proxy 254 may include an internalized component, shown as security token service (STS) component 255, which will provide token translation and will invoke authentication service runtime (ASR) 256 to validate and generate tokens. The security token service provides the token issuance and validation services required by the trust proxy. The security token service therefore includes an interface to existing authentication service runtimes, or it incorporates authentication service runtimes into the service itself. Rather than being internalized within the trust proxy, the security token service component may also be implemented as a stand-alone component, e.g., to be invoked by the trust proxy, or it may be internalized within the transaction server, e.g., as part of an application server.

For example, an STS component may receive a request to issue a Kerberos token. As part of the authentication information of the user for whom the token is to be created, the request may contain a binary token containing a username and password. The STS component will validate the username and password against, e.g., an LDAP runtime (typical authentication) and will invoke a Kerberos KDC (Key Distribution Center) to generate a Kerberos ticket for this user. This token is returned to the trust proxy for use within the enterprise; however, this use may include externalizing the token for transfer to another domain in the federation.

In a manner similar to that described with respect to FIG. 1D, a user may desire to access resources at multiple enterprises within a federated environment, such as both enterprise 250 and enterprise 260. In a manner similar to that described above for enterprise 250, enterprise 260 comprises point-of-contact server 262, trust proxy 264, security token service 265, and authentication service runtime 266. Although the user may directly initiate separate transactions with each enterprise, the user may initiate a transaction with enterprise 250 which cascades throughout the federated environment. Enterprise 250 may require collaboration with multiple other enterprises within the federated environment, such as enterprise 260, to complete a particular transaction, even though the user may not have been aware of this necessity when the user initiated a transaction. Enterprise 260 becomes involved as a downstream domain, and the present invention allows enterprise 250 to present a federated assertion to enterprise 260 if necessary in order to further the user's transaction.

It may be the case that a trust proxy does not know how to interpret the authentication token that is received by an associated point-of-contact server and/or how to translate a given user identity and attributes. In this case, the trust proxy may choose to invoke functionality at a trust broker component, such as trust broker 268. A trust broker maintains relationships with individual trust proxies, thereby providing transitive trust between trust proxies. Using a trust broker allows each entity within a federated environment, such enterprises 250 and 260, to establish a trust relationship with the trust broker rather than establishing multiple individual trust relationships with each domain in the federated environment. For example, when enterprise 260 becomes involved as a downstream domain for a transaction initiated by a user at enterprise 250, trust proxy 254 at enterprise 250 can be assured that trust proxy 264 at enterprise 260 can understand an assertion from trust proxy 254 by invoking assistance at trust broker 268 if necessary. Although FIG. 2C depicts the federated environment with a single trust broker, a federated environment may have multiple trust brokers.

It should be noted that although FIG. 2C depicts point-of-contact server 252, trust proxy 254, security token service component 255, and authentication service runtime 256 as distinct entities, it is not necessary for these components to be implemented on separate devices. For example, it is possible for the functionality of these separate components to be implemented as applications on a single physical device or combined in a single application. In addition, FIG. 2C depicts a single point-of-contact server, a single trust proxy, and a single security token server for an enterprise, but an alternative configuration may include multiple point-of-contact servers, multiple trust proxies, and multiple security token servers for each enterprise. The point-of-contact server, the trust proxy, the security token service, and other federated entities may be implemented in various forms, such as software applications, objects, modules, software libraries, etc.

A trust proxy/STS may be capable of accepting and validating many different authentication credentials, including traditional credentials such as a username and password combinations and Kerberos tickets, and federated authentication token formats, including authentication tokens produced by a third party. A trust proxy/STS may allow the acceptance of an authentication token as proof of authentication elsewhere. The authentication token is produced by an issuing party and is used to indicate that a user has already authenticated to that issuing party. The issuing party produces the authentication token as a means of asserting the authenticated identity of a user.

A security token service invokes an authentication service runtime as necessary. The authentication service runtime supports an authentication service capable of authenticating a user. The authentication service acts as an authentication authority that provides indications of successful or failed authentication attempts via authentication responses. The trust proxy/STS may internalize an authentication service, e.g., a scenario in which there is a brand-new installation of a web service that does not need to interact with an existing legacy infrastructure. Otherwise, the STS component will invoke external authentication services for validation of authentication tokens. For example, the STS component could “unpack” a binary token containing a username/password and then use an LDAP service to access a user registry to validate the presented credentials.

When used by another component such as an application server, the STS component can be used to produce tokens required for single-sign-on to legacy authentication systems. Hence, the STS component can be used for token translation for internal purposes, i.e. within an enterprise, and for external purposes, i.e. across enterprises in a federation. As an example of an internal purpose, a Web application server may interface to a mainframe via an IBM CICS (Customer Information Control System) transaction gateway; CICS is a family of application servers and connectors that provides enterprise-level online transaction management and connectivity for mission-critical applications. The Web application server may invoke the STS component to translate a Kerberos ticket (as used internally by the Web application server) to a an IBM RACF® passticket required by the CICS transaction gateway.

The entities that are shown in FIG. 2C can be explained using the terminology that was introduced above, e.g., “issuing party” and “relying party”. As part of establishing and maintaining trust relationships, an issuing party's trust proxy can determine what token types are required/accepted by a relying party's trust proxy. Thus, trust proxies use this information when invoking token services from a security token service. When an issuing domain's trust proxy is required to produce an authentication assertion for a relying party, the trust proxy determines the required token type and requests the appropriate token from the security token service.

When a relying domain's trust proxy receives an authentication assertion from an issuing party, the trust proxy knows what type of assertion that it expected and what type of assertion that it needs for internal use within the relying domain. The relying domain's trust proxy therefore requests that the security token service generate the required internal-use token based on the token in the received authentication assertion.

Both trust proxies and trust brokers have the ability to translate an assertion received from an issuing party into a format that is understood by a relying party. The trust broker has the ability to interpret the assertion format (or formats) for each of the trust proxies with whom there is a direct trust relationship, thereby allowing the trust broker to provide assertion translation between an issuing party and a relying party. This translation can be requested by either party through its local trust proxy. Thus, the issuing party's trust proxy can request translation of an assertion before it is sent to the relying party. Likewise, the relying party's trust proxy can request translation of an assertion received from an issuing party.

Assertion translation comprises user identity translation, authentication assertion translation, attribute assertion translation, or other forms of assertion translation. Reiterating the point above, assertion translation is handled by the trust components within a federation, i.e. trust proxies and trust brokers. A trust proxy may perform the translation locally, either at the issuing domain or at the relying domain, or a trust proxy may invoke assistance from a trust broker.

Assuming that an issuing party and a relying party already have individual trust relationships with a trust broker, the trust broker can dynamically create, i.e. broker, new trust relationships between issuing parties and relying parties if necessary. After the initial trust relationship brokering operation that is provided by the trust broker, the issuing party and the relying party may directly maintain the relationship so that the trust broker need not be invoked for future translation requirements. It should be noted that translation of authentication tokens can happen at three possible places: the issuing party's trust proxy, the relying party's trust proxy, and the trust broker. Preferably, the issuing party's trust proxy generates an authentication assertion that is understood by the trust broker to send to the relying party. The relying party then requests a translation of this token from the trust broker into a format recognizable by the relying party. Token translation may occur before transmission, after transmission, or both before and after transmission of the authentication assertion.

Trust relationships Within Federated Architecture

Within a federated environment that is implemented in accordance with the present invention, there are two types of “trust domains” that must be managed: enterprise trust domains and federation trust domains. The differences between these two types of trust domain are based in part on the business agreements governing the trust relationships with the trust domain and the technology used to establish trust. An enterprise trust domain contains those components that are managed by the enterprise; all components within that trust domain trust each other. In general, there are no business agreements required to establish trust within an enterprise because the deployed technology creates inherent trust within an enterprise, e.g., by requiring mutually authenticated SSL sessions between components. Referring to FIG. 2B, the legacy applications and back-end processing systems may represent an enterprise trust domain.

Federation trust domains are those that cross enterprise boundaries; from one perspective, a federation trust domain may represent trust relationships between distinct enterprise trust domains. Federation trust domains are established through trust proxies across enterprise boundaries. Federated trust relationships involve some sort of a bootstrapping process by which initial trust is established between trust proxies. Part of this bootstrap process may include the establishment of shared secret keys and rules that define the expected and/or allowed token types and identifier translations. In general, this bootstrapping process is implemented out-of-band as this process also includes the establishment of business agreements that govern an enterprise's participation in a federation and the liabilities associated with this participation.

There a number of mechanisms for establishing trust in a federated business model. In a federation model, a fundamental notion of trust between the federation participants is required for business reasons in order to provide a level of assurance that the assertions (including tokens and attribute information) that are transferred between the participants are valid. If there is no trust relationship, then the relying domain cannot depend upon the assertions received from the issuing domain; they cannot be used by the relying domain to determine how to interpret any information received from the issuing party.

For example, a large corporation may want to link several thousand global customers, and the corporation could use prior art solutions. As a first example, the corporation could require global customers to use a digital certificate from a commercial certificate authority to establish mutual trust. The commercial certificate authority enables the servers at the corporation to trust servers located at each of the global customers. As a second example, the corporation could implement third-party trust using Kerberos; the corporation and its global customers could implement a trusted third-party Kerberos domain service that implements shared-secret-based trust. As a third example, the corporation could establish a private scheme with a proprietary security message token that is mutually trusted by the servers of its global customers.

Any one of these approaches may be acceptable if the corporation needed to manage trust relationships with a small number of global customers, but this may become unmanageable if there are hundreds or thousands of potential federation partners. For example, while it may be possible for the corporation to force its smaller partners to implement a private scheme, it is unlikely that the corporation will be able to impose many requirements on its larger partners.

With the present invention, the enterprise will employ trust relationships established and maintained through trust proxies and possibly trust brokers. An advantage of the federated architecture of the present invention is that it does not impose additional requirements above and beyond the current infrastructures of an enterprise and its potential federation partners.

However, the present invention does not relieve an enterprise and its potential federation partners from the preliminary work required to establish business and liability agreements that are required for participation in the federation. In addition, the participants cannot ignore the technological bootstrapping of a trust relationship. The present invention allows this bootstrapping to be flexible, e.g., a first federation partner can issue a Kerberos ticket with certain information, while a second federation partner can issue a SAML authentication assertion with certain information.

In the present invention, the trust relationships are managed by the federation trust proxies, which may include a security token service that validates and translates a token that is received from an issuing party based on the pre-established relationship between two trust proxies. In situations where it is not feasible for a federated enterprise to establish trust relationships (and token translation) with another federated enterprise, a trust broker may be invoked. However, the federated enterprise must still establish a relationship with a trust broker.

With reference now to FIG. 2D, a block diagram depicts an exemplary set of trust relationships between federated domains using trust proxies and a trust broker in accordance with the present invention. Although FIG. 2C introduced the trust broker, FIG. 2D illustrates the importance of transitive trust relationships within the federated architecture of the present invention.

Federated domains 271-273 incorporate trust proxies 274-276, respectively. Trust proxy 274 has direct trust relationship 277 with trust proxy 275. Trust broker 280 has direct trust relationship 278 with trust proxy 275, and trust broker 280 has direct trust relationship 279 with trust proxy 276. Trust broker 280 is used to establish, on behalf of a federation participant, a trust relationship based on transitive trust with other federation partners. The principle of transitive trust allows trust proxy 275 and trust proxy 276 to have brokered trust relationship 281 via trust broker 280. Neither trust proxy 275 nor 276 need to know how to translate or validate the other's assertions; the trust broker may be invoked to translate an assertion into one that is valid, trusted, and understood at the other trust proxy.

Business agreements that specify contractual obligations and liabilities with respect to the trust relationships between federated enterprises can be expressed in XML through the use of the ebXML (Electronic Business using XML) standards. For example, a direct trust relationship could be represented in an ebXML document; each federated domain that shares a direct trust relationship would have a copy of a contract that is expressed as an ebXML document. Operational characteristics for various entities within a federation may be specified within ebXML choreographies and published within ebXML registries; any enterprise that wishes to participate in a particular federation, e.g., to operate a trust proxy or trust broker, would need to conform to the published requirements that were specified by that particular federation for all trust proxies or trust brokers within the federation. A security token service could parse these ebXML documents for operational details on the manner in which tokens from other domains are to be translated. It should be noted, though, that other standards and mechanisms could be employed by the present invention for specifying the details about the manner in which the trust relationships within a federation are implemented.

Assertion Processing Within Federated Architecture

As noted above, a user's experience within a federation is governed in part by the assertions about the user or for the user that are transferred across domains. Assertions provide information about the user's authentication status, attribute information, and other information. Using authentication assertions can remove the need for a user to re-authenticate at every site that the user visits. Within a federated environment, there are two models to get an assertion from an issuing party to a relying party: push models and pull models. In a push model, the user's assertions travel with the user's request to the issuing party. In a pull model, the user's request is received at a relying party without any information, and the relying party then requests the relevant or required assertions from the issuing party.

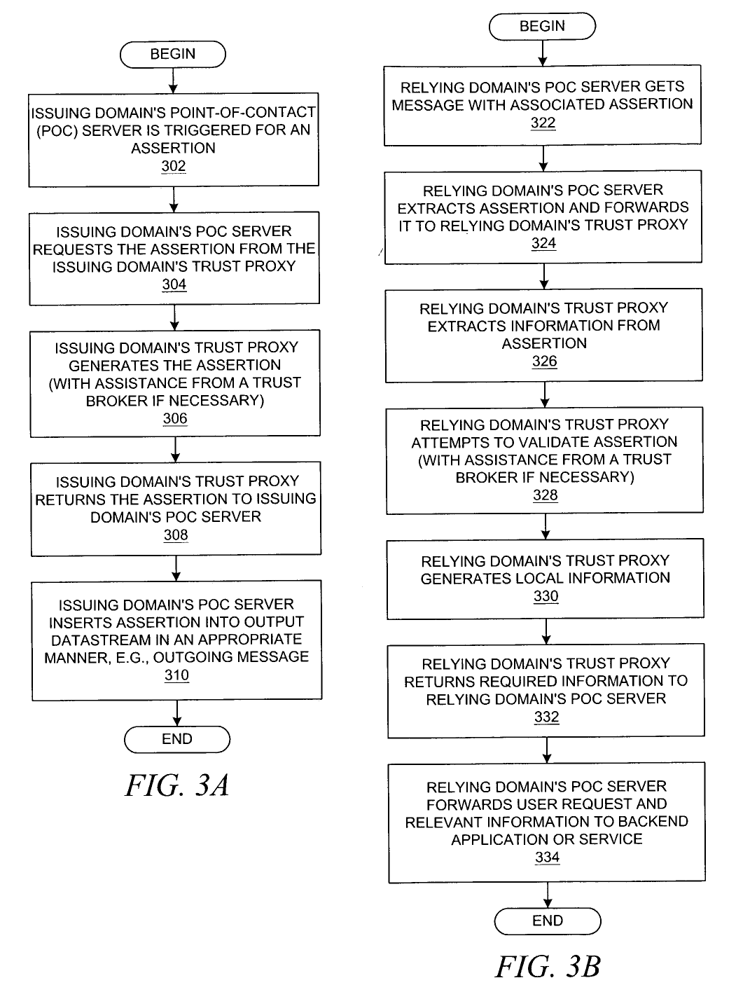

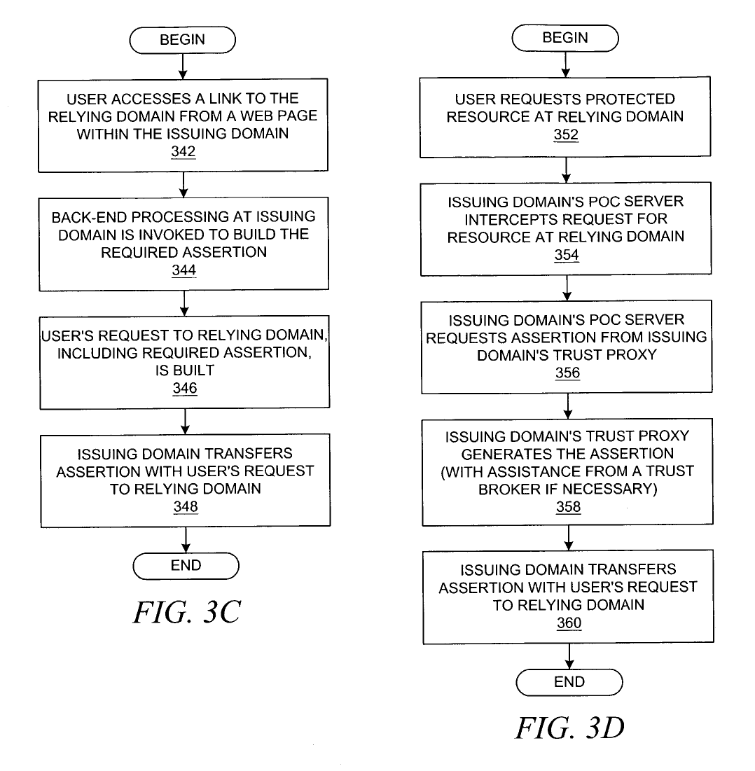

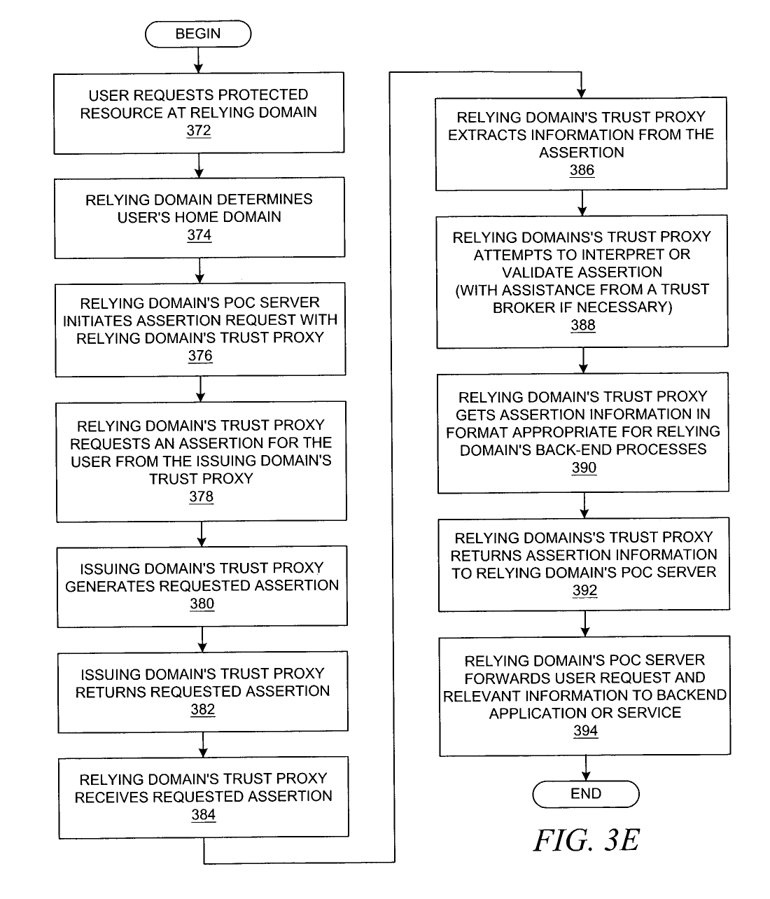

Given these models for using assertions within a federated environment, the description of the present invention now turns to a set of figures that describe a set of processes for creating and using assertions within the federated environment of the present invention. FIG. 3A depicts a generalized process at an issuing domain for creating an assertion within a federated environment, whereas FIG. 3B depicts a generalized process at a relying domain for “tearing down” an assertion, i.e. for reducing an assertion to its essential information by extracting and analyzing its information. FIG. 3C and FIG. 3D show more detailed processes for the generalized process that is shown in FIG. 3A by depicting two variants of a push model in which an assertion is produced within an issuing domain and is then transferred with a user's request to the relying domain. FIG. 3E depicts a pull model in which a relying domain requests any required assertions for a user from an issuing domain while attempting to satisfy a resource request that was received by the relying domain from the requesting user.

With reference now to FIG. 3A, a flowchart depicts a generalized process at an issuing domain for creating an assertion within a federated environment. The process begins when the issuing domain's point-of-contact server is triggered for an assertion (step 302). The point-of-contact server may receive a request for a particular assertion for a given user from a relying domain, or it may intercept an outgoing request to a known relying domain that requires an assertion; these scenarios are described in more detail below with respect to FIG. 3C and FIG. 3D, respectively. In response to being triggered for an assertion, the issuing domain's point-of-contact server requests the assertion from the issuing domain's trust proxy (step 304), which generates the assertion (step 306); the issuing domain's trust proxy may request assistance from a trust broker to generate the required assertion if necessary. After generating the assertion, the issuing domain's trust proxy then returns the assertion to the issuing domain's point-of-contact server (step 308), which then injects the assertion into the output datastream in an appropriate manner (step 310), e.g., by inserting the assertion into an outgoing HTTP or SOAP message, thereby completing the process.

FIG. 3A depicts a process for creating an assertion at an issuing domain without the use of a “local wallet”. However, the present invention allows for the inclusion of local wallet functionality. In general, a local wallet is client-side code that may act as a secure datastore for user attribute information or other information for facilitating transactions; the client-side code may also participate in the push and/or pull models of assertion transfer. When the local wallet actively participates in the protocol, it implements a subset of the functionality of the point-of-contact server functionality in terms of generating and inserting assertions into the protocol flow. Using a local wallet does not allow for the local wallet to implement the trust-based interactions that occur between a point-of-contact server and the trust proxy. In cases in which additional trust relationships are required, the point-of-contact server must be invoked.

With reference now to FIG. 3B, a flowchart depicts a generalized process at a relying domain for tearing down an assertion. The process begins when a relying domain's point-of-contact server receives a message with an associated assertion (step 322), after which it extracts the assertion and forwards the assertion to the relying domain's trust proxy (step 324). The relying domain's trust proxy extracts information from the assertion, including the token received from the issuing domain (step 326); the relying domain's trust proxy will invoke the security token service to validate this token, returning a locally valid token for the user if appropriate (step 328).

As part of step 326, the trust proxy will determine the source, i.e. issuing party, of the assertion. If the trust proxy is able to understand a trust assertion received from this issuing domain, the trust proxy will perform step 328 internally. If the trust proxy is not able to understand/trust assertions received from the issuing domain, the trust proxy may invoke assistance from a trust broker. If the assertion cannot be validated, then an appropriate error response would be generated.

Assuming that the assertion is validated, then the relying domain's trust proxy builds the local information that is required for the user (step 330). For example, the local information may include authentication credentials that are required by a back-end legacy application. The relying domain's trust proxy returns the required information to the relying domain's point-of-contact server (step 332), which builds a local session for the user.

After the point-of-contact server builds a session for user, the user appears as an authenticated user. The point-of-contact server can use this session information to further govern any transactions the user has with the domain until a logout or timeout event is initiated. Given that the point-of-contact server has an authenticated identity for the user, the point-of-contact server may obtain authorization for this request if necessary based on this particular user's identity and any authorization policies that are associated with this particular user. The point-of-contact server then forwards the user's request with any relevant information to the requested back-end application or service (step 334), thereby completing the process.

It should be noted that the data items that are transferred between the point-of-contact server and the trust proxy and the format of those data items may vary. Rather than extracting an assertion from the message and forwarding only the assertion to the trust proxy, the point-of-contact server may forward the entire message to the trust proxy. For example, the processing at the trust proxy may include steps like signature validation on a SOAP message, which would require the entire SOAP envelope.

With reference now to FIG. 3C, a flowchart depicts a specific process for pushing an assertion from an issuing domain to a relying domain in response to a user action at the issuing domain. The process begins when a user accesses a link to the relying domain from a Web page or similar resource within the issuing domain (step 342), thereby invoking some form of CGI-type (Common Gateway Interface) processing to build a particular assertion. The ability of the issuing domain to recognize the need for an assertion by the relying domain implies a tight integration with an existing legacy system on which the federated infrastructure of the present invention is implemented. It also implies a tight coupling between the issuing party and relying party such that the issuing party does not need to invoke a trust proxy to build the required assertion; this tight coupling may be appropriate between certain types of federated entities that have well-established trust relationships.

Back-end processing at the issuing domain is invoked to build the required assertion (step 344), which may include invoking functionality at the local trust proxy. The user's request to the relying domain, including the required assertion, is then built (step 346), and the issuing domain transfers the assertion along with the user's request to the relying domain (step 348), thereby completing the process. When the relying domain receives the request and its associated assertion, then the relying domain would validate the assertion in the manner shown in FIG. 3B.

With reference now to FIG. 3D, a flowchart depicts a specific process for pushing an assertion from an issuing domain to a relying domain in response to the issuing domain actively intercepting an outgoing request to the relying domain. The process begins when a user requests a protected resource at the relying domain (step 352). The point-of-contact server intercepts the outgoing request (step 354), e.g., by filtering outgoing messages for predetermined Uniform Resource Identifiers (URI's), certain types of messages, certain types of message content, or in some other manner. The issuing domain's point-of-contact server then requests the generation of an appropriate assertion from the issuing domain's trust proxy (step 356), which generates the assertion with assistance from a trust broker if necessary (step 358). The issuing domain then transfers the user's request along with the generated assertion to the relying party (step 360), thereby completing the process. When the relying domain receives the request and its associated assertion, then the relying domain would validate the assertion in the manner shown in FIG. 3B.

With reference now to FIG. 3E, a flowchart depicts a pull model in which a relying domain requests any required assertions for a user from an issuing domain while attempting to satisfy a resource request that was received by the relying domain from the requesting user. The process begins when the relying domain receives a user request for a protected resource (step 372). In contrast to the examples shown in FIG. 3C or FIG. 3D, the example that is shown in FIG. 3E describes the processing that is associated with a user's request that is received at a relying domain in absence of any required assertions about a user. In this case, the issuing domain has not had the ability to intercept or otherwise process the user's request in order to insert the required assertions in the user's request. For example, the user might have entered a Uniform Resource Locator (URL) or used a bookmarked reference to a resource in such a way that the outgoing request was not intercepted by an issuing domain's point-of-contact server. Hence, the relying domain requests the assertion from an issuing domain.

The relying domain then determines the user's home domain (step 374), i.e. the relevant issuing domain. In an HTTP-based implementation, the user may have pre-established a relationship with the relying domain that resulted in a persistent cookie being set by the relying domain at the user's client device. The persistent cookie would contain an identity of the user's home domain, i.e. issuing domain. In a SOAP-based implementation in which the user is operating a web services client in some manner, the web service at the relying domain would have advertised the services requirements via WSDL (Web Services Description Language), including token requirements. This would then require the user's web services client/SOAP implementation to provide the required token type. If this requirement was not fulfilled, then the web service would technically return an error. In some cases, it may return an error code that would allow the user's web services client to be prompted for authentication information so that the request could be repeated with the appropriate token.

The relying domain's point-of-contact server initiates an assertion request with the relying domain's trust proxy (step 376), which requests an assertion for the user from the issuing domain's trust proxy (step 378). If the embodiment is employing HTTP-based communication, then an assertion request from the relying domain's trust proxy to the issuing domain's trust proxy may be transmitted by the relying domain's point-of-contact server via redirection through the user's browser application to the point-of-contact server at the issuing domain, which forwards the assertion request to the issuing domain's trust proxy.

If the embodiment is employing a SOAP-based implementation, then the relying party may return an error code to the user's web service client. This error code allows the user to be prompted for authentication information by their web services client. The web services client would then generate the requested token. The user's web services client could invoke a trust proxy directly provided that the relying domain's trust proxy was advertised in a UDDI (Universal Description, Discovery, and Integration) registry, allowing the user's web services client to find the trust proxy. In general, this scenario is valid only for an internal user, where the trust proxy was advertised in a private UDDI within the enterprise because it is not likely that a trust proxy will be advertised in a public UDDI on the Internet or generally accessible outside of a federation.

The issuing domain's trust proxy generates (step 380) and then returns the requested assertion (step 382) in a manner that mirrors the manner in which the assertion request was received. After the relying domain's trust proxy receives the requested assertion (step 384), then the relying domain's trust proxy extracts information from the assertion (step 386) and attempts to interpret and/or validate the assertion (step 388); the trust proxy may invoke assistance from a trust broker if necessary for translation of the assertion. If the assertion cannot be validated, then an appropriate error response would be generated. Assuming that the assertion is validated, then the relying domain's trust proxy builds the local information in an appropriate format that is required for use by the back-end services that will attempt to fulfill the user's request for the protected resource (step 390). For example, the local information may include authentication credentials that are required by a back-end legacy application. The relying domain's trust proxy returns the required information to the relying domain's point-of-contact server (step 392), which then builds a local session for the user and forwards the user's request with any relevant information to the requested back-end application or service (step 394), thereby completing the process.

Single-Sign-On Within Federated Architecture

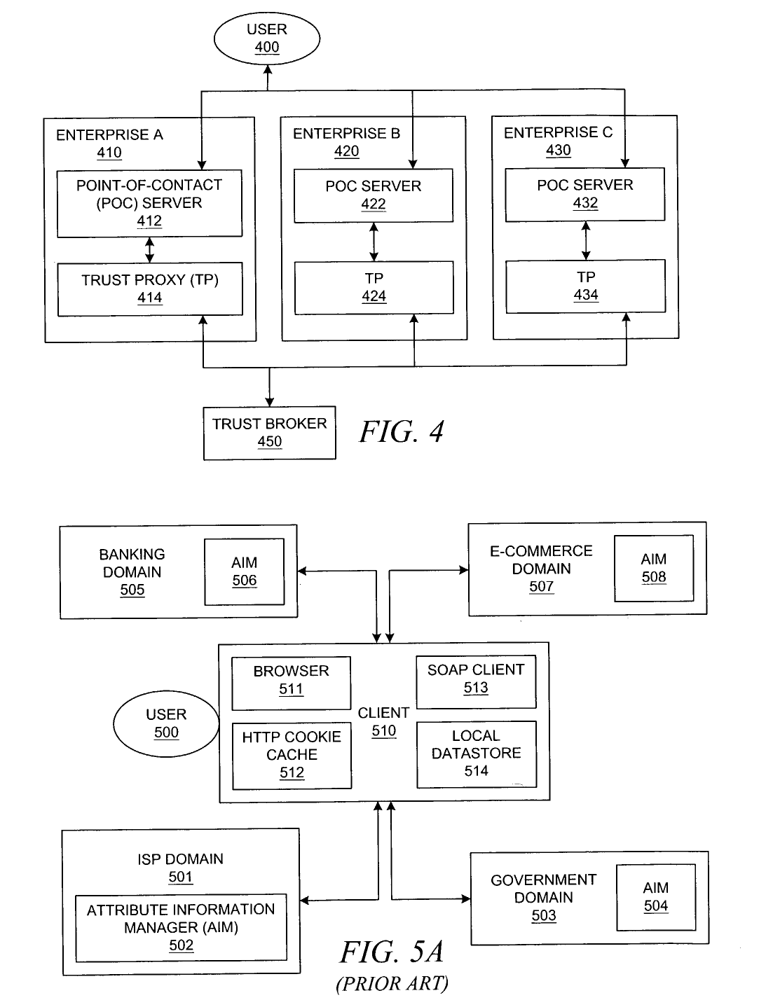

The description of FIGS. 2A-2D focuses on the operational characteristics of entities within a federated data processing environment in accordance with the present invention, whereas the description of FIGS. 3A-3E focuses on some of the processes that occur between those entities. In contrast to these descriptions, reference is made to FIG. 4 for a description of the present invention that focuses on the goals of completing transactions for a user while providing a single-sign-on experience for the user.

In other words, the description hereinbelow discusses the entities and processes that were already discussed above, although the following description focuses more on an overview perspective of the present invention with respect to the manner in which a user can have a single-sign-on experience within the user's session. A session can be defined as the set of transactions from (and including) the initial user authentication, i.e. logon, to logout. Within a session, a user's actions will be governed in part by the privileges granted to the user for that session. Within a federation, a user expects to have a single-sign-on experience in which the user completes a single authentication operation, and this authentication operation suffices for the duration of their session, regardless of the federation partners visited during that session.

During the user's session, the user may visit many federated domains to use the web services that are offered by those domains. Domains can publish descriptions of services that they provide using standard specifications such as UDDI and WSDL, both of which use XML as a common data format. The user finds the available services and service providers through applications that also adhere to these standard specifications. SOAP provides a paradigm for communicating requests and responses that are expressed in XML. Entities within a federated environment may employ these standards among others.

To facilitate a single-sign-on experience, web service that support the federated environment will also support using an authentication assertion or security token generated by a third-party to provide proof of authentication of a user. This assertion will contain some sort of evidence of the user's successful authentication to the issuing party together with an identifier for that user. Thus, a user may present traditional authentication credentials to one federation partner, e.g., username and password, and then provide a SAML authentication assertion that is generated by the authenticating/issuing party to a different federation partner.

Authentication in a web services environment is the act of verifying the claimed identity of the web services request so that the enterprise can restrict access to authorized clients. A user who requests or invokes a web service would almost always authenticated, so the need for, authentication within the federated environment of the present invention is not any different from current requirements of web services for user authentication. The federated environment also allows web services or other applications to request web services, and these web services would also be authenticated.

Authentication of users that are not participating in a federated session are not impacted by the federated architecture of the present invention. For example, an existing user who authenticates with a forms-based authentication mechanism over HTTP/S to access non-federated resources at a particular domain is not affected by the introduction of support at the domain for the federated environment. Authentication is handled in part by a point-of-contact server, which in turn may invoke a separate trust proxy component. The use of a point-of-contact server minimizes the impact on the infrastructure of an existing domain. For example, the point-of-contact server can be configured to pass through all non-federated requests to be handled by the back-end or legacy applications and systems at the domain.

The point-of-contact server may choose to invoke an HTTP-based authentication method, such as basic authentication, forms-based authentication, or some other authentication method. The point-of-contact server also supports a federated trust domain by recognizing an assertion that has been presented by the user as proof of authentication, such as an SAML authentication assertion, wherein the assertion has crossed between enterprise trust domains. The point-of-contact server may invoke the trust proxy, which in turn may invoke its security token service for validation of authentication credentials/security tokens.

Authentication of web services or other applications comprises the same process as authentication of users. Requests from web services carry a security token containing an authentication assertion, and this security token would be validated by the trust proxy/security token service in the same manner as a token presented by a user. A request from a web service should always carry this token with it because the web service would have discovered what authentication assertions/security tokens were required by the requested service as advertised in UDDI.

With reference now to FIG. 4, a block diagram depicts a federated environment that supports federated single-sign-on operations. User 400, through a client device and an appropriate client application, such as a browser, desires to access a web service that is provided by enterprise/domain 410, which supports data processing systems that act as a federated domain within a federated environment. Domain 410 supports point-of-contact server 412 and trust proxy 414; similarly, domain 420 supports point-of-contact server 422 and trust proxy 424, while domain 430 supports point-of-contact server 432 and trust proxy 434. The trust proxies rely upon trust broker 450 for assistance, as described above. Additional domains and trust proxies may participate in the federated environment. FIG. 4 describes a federated single-sign-on operation between domain 410 and domain 420; a similar operation may occur between domain 410 and domain 430.

The user completes an authentication operation with respect to domain 410; this authentication operation is handled by point-of-contact server 412. The authentication operation is triggered when the user requests access to some resource that requires an authenticated identity, e.g., for access control purposes or for personalization purposes. Point-of-contact server 412 may invoke a legacy authentication service, or it may invoke trust proxy 414 to validate the user's presented authentication credentials. Domain 410 becomes the user's home domain for the duration of the user's federated session.

At some later point in time, the user initiates a transaction at a federation partner, such as enterprise 420 that also supports a federated domain, thereby triggering a federated single-sign-on operation. For example, a user may initiate a new transaction at domain 420, or the user's original transaction may cascade into one or more additional transactions at other domains. As another example, the user may invoke a federated single-sign-on operation to a resource in domain 420 via point-of-contact server 412, e.g., by selecting a special link on a web page that is hosted within domain 410 or by requesting a portal page that is hosted within domain 410 but that displays resources hosted in domain 420. Point-of-contact server 412 sends a request to trust proxy 414 to generated a federation single-sign-on token for the user that is formatted to be understood or trusted by domain 420. Trust proxy 414 returns this token to point-of-contact server 412, which sends this token to point-of-contact server 422 in domain. Domain 410 acts as an issuing party for the user at domain 420, which acts as a relying party. The user's token would be transferred with the user's request to domain 420; this token may be sent using HTTP redirection via the user's browser, or it may be sent by invoking the request directly of point-of-contact server 422 (over HTTP or SOAP-over-HTTP) on behalf of the user identified in the token supplied by trust proxy 414.

Point-of-contact server 422 receives the request together with the federation single-sign-on token and invokes trust proxy 424. Trust proxy 424 receives the federation single-sign-on token, validates the token, and assuming that the token is valid and trusted, generates a locally valid token for the user. Trust proxy 424 returns the locally valid token to point-of-contact server 422, which establishes a session for the user within domain 420. If necessary, point-of-contact server 422 can initiate a federated single-sign-on at another federated partner.

Validation of the token at domain 420 is handled by the trust proxy 424, possibly with assistance from a security token service. Depending on the type of token presented by domain 410, the security token service may need to access a user registry at domain 420. For example, domain 420 may provide a binary security token containing the user's name and password to be validated against the user registry at domain 420. Hence, in this example, an enterprise simply validates the security token from a federated partner. The trust relationship between domains 410 and 420 ensures that domain 420 can understand and trust the security token presented by domain 410 on behalf of the user.

Federated single-sign-on requires not only the validation of the security token that is presented to a relying domain on behalf of the user but the determination of a locally valid user identifier at the relying domain based on information contained in the security token. One result of a direct trust relationship and the business agreements required to establish such a relationship is that at least one party, either the issuing domain or the relying domain or both, will know how to translate the information provided by the issuing domain into an identifier valid at the relying domain. In the brief example above, it was assumed that the issuing domain, i.e. domain 410, is able to provide the relying domain, i.e. domain 420, with a user identifier that is valid in domain 420. In that scenario, the relying domain did not need to invoke any identity mapping functionality. Trust proxy 424 at domain 420 will generate a security token for the user that will “vouch-for” this user. The types of tokens that are accepted, the signatures that are required on tokens, and other requirements are all pre-established as part of the federation's business agreements. The rules and algorithms that govern identifier translation are also pre-established as part of the federation's business agreements. In the case of a direct trust relationship between two participants, the identifier translation algorithms will have been established for those two parties and may not be relevant for any other parties in the federation.

However, it is not always the case that the issuing domain will know how to map the user from a local identifier for domain 410 to a local identifier for domain 420. In some cases, it may be the relying domain that knows how to do this mapping, while in yet other cases, neither party will know how to do this translation, in which case a third party trust broker may need to be invoked. In other words, in the case of a brokered trust relationship, the issuing and relying domains do not have a direct trust relationship with each other. They will, however, have a direct trust relationship with a trust broker, such as trust broker 450. Identifier mapping rules and algorithms will have been established as part of this relationship, and the trust broker will use this information to assist in the identifier translation that is required for a brokered trust relationship.

Domain 420 receives the token that is issued by domain 410 at point-of-contract server 422, which invokes trust proxy 424 to validate the token and perform identity mapping. In this case, since trust proxy 424 is not able to map the user from a local identifier for domain 410 to a local identifier for domain 420, trust proxy 424 invokes trust broker 450, which validates the token and performs the identifier mapping. After obtaining the local identifier for the user, trust proxy 424, possibly through its security token service, can generate any local tokens that are required by the back-end applications at domain 420, e.g., a Kerberos token may be required to facilitate single-sign-on from the point-of-contact server to the application server. After obtaining a locally valid token, if required, the point-of-contact server is able to build a local session for the user. The point-of-contract server will also handle coarse-grained authorization of user requests and forward the authorized requests to the appropriate application servers within domain 420.

A user's session is terminated when they logout or sign-off. When a user logs out of a session with their home domain, then the home domain would notify all relying domains, i.e. those domains to which it has issued a security token, and invoke a user logout at these domains. If any of these relying domains has in turn acted as an issuing domain for the same user, then they would also notify all of their relying domains about the user logout request in a cascading fashion. The trust proxy at each domain would be responsible for notifying all relying domains of the user's logout request, and the trust proxy may invoke the trust broker as part of this process.

User-Determined Attribute Storage Within Federated Environment

FIG. 1C and FIG. 1D focus on user authentication operations. In general, after a user has been authenticated within a domain, it may be assumed that the domain provides user access to various resources. Although the authentication process merely establishes the identity of a user, in some domains, the identity of a user may be sufficient information in a determination to provide access to resources. In these domains, access to resources may be provided to all authenticated users. In other domains, however, when a user requests a resource, a resource manager within a domain may need additional information about the user, i.e. user attributes, before performing an action on behalf of the user. Typically, the identity of the user is employed to obtain user attributes that have been previously associated with the user. After the resource manager obtains the necessary user attributes, the resource manager provides the resource to the user after employing the retrieved user attributes in some manner, e.g., in a personalization operation or an authorization operation. The local entity that manages user attributes at a typical service provider within an enterprise or domain may be generally termed an attribute information manager (AIM).

A variety of resource managers may operate within a domain or at different domains, and each resource manager may require user attributes for a particular purpose. For example, an authorization server may need user attributes in order to determine whether a user has the proper privilege attributes to access a particular resource in accordance with access control policies associated with a resource. If the user has the necessary privilege attributes, then the authorization server provides the resource to the user. In another example, a content server may require user attributes in order to personalize in some manner the content that is returned to the user. The content server may limit or modify the content that is sent to the user based on user attributes, e.g., gender, for marketing or other purposes.

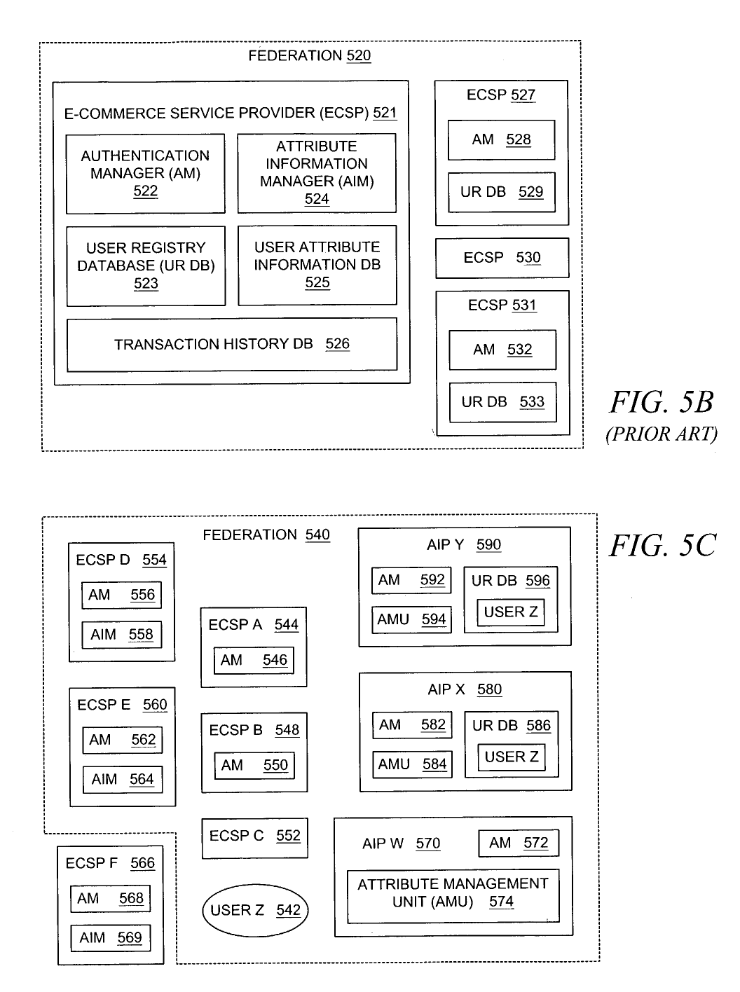

With reference now to FIG. 5A, a block diagram depicts an example of a typical online transaction that requires user attributes. FIG. 5A is similar to FIG. 1E, which is an example of a typical online transaction that might require multiple authentication operations from a user. In contrast, FIG. 5A illustrates some of the difficulties that a user may experience when accessing multiple domains that require the user to provide user information. Referring again to FIG. 1C and FIG. 1D, a user may be required to complete an authentication operation prior to gaining access to a controlled resource, as shown in FIG. 1C. Although not shown in FIG. 1C, an attribute information manager may be deployed on server 151 to manage user attributes that are required for an access control decision. As shown in FIG. 1D, a user may have multiple current sessions within different domains 173 and 175, and although they are not shown in FIG. 1D, each domain may employ an attribute information manager. In a similar manner, FIG. 5A also depicts a set of domains, each of which may support some type of attribute information manager.

User 500 may be registered at domain 501, which may support attribute information manager 502 that manages user attributes for user 500. Domain 501 may be an Internet Service Provider (ISP) that provides Internet connection services, email services, and possibly other e-commerce services. Alternatively, domain 501 may be an Internet portal that is frequently accessed by user 500. Domain 501 may store a wide-ranging set of user attributes for user 500, including personal, financial, and administrative attributes, which might include content preferences.

Government domain 503 supports attribute information manager 504 that manages various government-related attributes about user 500. Banking domain 505 supports attribute information manager 512 that manages various attributes for a bank. E-commerce domain 507 similarly supports attribute information manager 508.

Each of the above-noted domains may use some form of storage on client 510 that is operated by user 500 in order to accomplish certain operations on behalf of client 510. For example, if user 500 is using browser application 511 to access an application that is supported by a domain, then the domain may set an HTTP cookie in cookie cache 512. If user 500 is using some other application, e.g., an application that incorporates functionality to act as SOAP client 513, then local datastore 514 may be used as client-side storage.

As noted previously, when a user attempts to move from one domain to another domain within the Internet or World Wide Web by accessing resources at the different domains, a user may be subjected to multiple user information requests or requirements, which can significantly slow the user's progress across a set of domains. Subjecting a user to multiple information requests or requirements in a short period of time may significantly affect the user's ability to complete transactions efficiently. Using FIG. 5A as an exemplary environment, user 500 may be involved in a complicated online transaction with e-commerce domain 507 in which the user is attempting to purchase an on-line service that is limited to users who are at least 18 years old and who have a valid driver license, a valid credit card, and a U.S. bank account.

Although user 500 should be able to provide all of the required user attribute information to domain 507, it requires time and patience to enter the information, particularly when user 500 may be frustrated by the fact that all of this user attribute information is already stored somewhere within the other domains. For example, user 500 may have previously visited e-commerce domain 507 and purchased a different on-line service. During the prior transaction, user 500 may have only been required to provide a credit card number, but user 500 may or may not have given permission to domain 507 to store the credit card number in a user profile that is managed by attribute information manager 508. However, if user 500 was not required to provide any other user attribute information for the prior transaction, domain 507 would not have access to the user attribute information that is required for the current transaction. Attribute information manager 506 at domain 505 has the user's bank account information, which may be required by domain 507 as a backup payment source if a credit card transaction is declined. Attribute information manager 504 at government domain 503 has the user's driver license information, yet neither domain 503 nor domain 505 support a mechanism for transferring user attribute information to domain 507. User 500 must somehow have all of this user attribute information communicated to domain 507 in a secure and authenticatable manner before user 500 will receive the desired on-line service.

In the context of the World Wide Web, users are coming to expect the ability to interact with an application on one Internet domain to another application on another domain with minimal regard to the information barriers between each particular domain. Users do not want the frustration that is caused by the scenario shown in FIG. 5A, particularly if the users know that the domains are somehow affiliated in a federated environment. In other words, users expect that organizations within a federated environment should interoperate at a much higher level than unaffiliated domains. Moreover, users generally want domains to respect their privacy. In addition, users may prefer to limit the domains that permanently store their private information, thereby limiting the effects of unauthorized disclosure of personal information, e.g., the after-effects of a domain whose security has been breached. User preferences may vary with the identity of the domain or the nature of the information that is used by the domain.

Given the preceding brief description of current technology and a few of its associated problems, the description of the remaining figures relates to federated computer environments in which the present invention may operate. Prior to discussing the present invention in more detail, however, some terminology is introduced.

A typical networked computing environment can be broadly described as comprising users and service providers. A service provider delivers some form of information, informational access, or access to resources to a user electronically via computer systems and networks, such as those shown in FIG. 1A. A user may be regarded as a consumer of the provided service. In general, many different types of service providers may be present in a given networked environment, such as the environment shown in FIG. 5A. Online merchants represent a class of e-commerce service providers, while Web portals represent a class of information service providers. Internet service providers are entities that provide a network communication link to the Internet as a service.

An enterprise may be regarded as the business entity, such as a corporation, that operates a service provider. Although not meant to be limiting in the interpretation of the present invention, a service may be regarded as a defined function or a defined set of functions; the service may be made available to a user, enterprise, or other entity, or alternatively, the product of a service may be delivered to a user, enterprise, or other entity. A service provider may make a particular service available in response to a variety of circumstances: after entering into a financial or contractual agreement, after merely receiving a simple request, or after some other type of exchange. For example, some Web sites restrict access to valuable information to paying customers, whereas other Web sites operate by making content freely available to all requesting entities while interjecting advertisements into the content. With respect to the present invention, a service provider may be regarded as the data processing systems and the communication facilities that electronically deliver or make available a particular type of functionality.

In a typical computing environment, enterprises communicate with each other by adhering to communication protocols and other types of standards, but the enterprises do not necessarily agree to provide services in a common manner. Typically, an enterprise has its own user registry and maintains relationships with its own set of users; each enterprise typically has its own means of authenticating its users. In addition, each enterprise typically has its own means for managing user attribute information, as described above with respect to FIG. 5A. The self-contained nature of these enterprises gives rise to the above-mentioned informational barriers within the typical computing environment.

With reference now to FIG. 5B, a block diagram depicts a typical federated computing environment. Since a federated computing environment is a type of computing environment, a federated computing environment can also be broadly described as comprising users and service providers. Federation 520 comprises multiple service providers. In order to facilitate the description of user transactions within a federated environment and to distinguish among various types of service providers, a particular type of service provider is primarily used within the following examples: an e-commerce service provider (ECSP). E-commerce service providers correspond to business entities that are participating in a federation; hence, it should be understood that the e-commerce service providers that are described in the following examples may represent any entity that provides a service or provides access to resources for users, which may include e-commerce entities like banks and online merchants but may include information providers or other content or service providers.

The service providers within federation 520 support a variety of functional capabilities. ECSP 521 supports authentication manager 522 for verifying the identity of users who have registered with ECSP 521 as indicated by user registry database 523. ECSP 521 also supports attribute information manager 524, which manages user attribute information that is stored in user attribute information database 526 on behalf of the registered users of ECSP 521. ECSP 521 also maintains transaction history database 526.

In a typical computing environment, a service provider requires user attribute information for a given user in order to provide some type of service for the given user. As described above with respect to FIG. 5A, a service provider queries a user to obtain the required user attribute information, after which the service provider may or may not store the user attribute information. The same circumstances apply in a federated computing environment; in other words, a service provider in a federated environment may or may not have a need for user attribute information, and a service provider in a federated environment may or may not manage user attribute information by itself. In contrast with ECSP 521, ECSP 527 supports authentication manager 528 and its user registry database 529 but does not support an attribute information manager. Hence, ECSP 527 is able to provide restricted access to resources or customized user responses based upon an authenticated identity of a user but not based upon user attribute information. As an example of a more limited service provider, ECSP 530 does not support an authentication manager nor an attribute information manager, whereas ECSP 531 is similar to ECSP 527 and supports authentication manager 532 and its user registry database 533.

As in a typical computing environment, a user may register at more than one service provider or federated domain within a federated computing environment. For example, a user may be registered through the user's employer, the user's ISP, or some other service provider. Registration is an operation in which a user provides identity information to a domain in order to establish a permanent relationship with the domain; thereafter, the domain recognizes the user through some form of authentication credentials. In FIG. 5B, a user may register at any domain that has the capability of registering users, such as ECSP 521, ECSP 527, or ECSP 531.

As shown in FIG. 5B, since a federated domain at which a particular user has registered does not necessarily store user attribute information, the user's home domain may or may not maintain user attribute information for the user. In other words, a home domain may be able to authenticate a user but does not necessarily store any personal information or profile information for the user other than what is required to authenticate the user.

A home domain may or may not comprise any additional functionality for asserting its status as a user's home domain in comparison with other domains; in other words, the distinction as a user's home domain may be formal or informal. As a formal example, a user may obtain Internet access from a federated ISP domain, and thereafter, the ISP domain may function as the user's home domain by providing authentication assertions to other federated domains. As an informal example, a user may frequently access a Web portal that the user considers as a primary location for receiving information and conducting online transactions. In either of these cases, the domain from which the user regards as the starting location for the initiation of most of the user's transactions within the federation may be considered by the user to be the user's home domain. Alternatively, the federation may formally designate a particular registered domain as a home domain.

In addition, a federated domain may be considered to be a user's home domain for a particular purpose. Hence, a user may have concurrent specialized home domains during a particular federated session. For example, an ISP domain may act as an authentication home domain by providing authentication assertions on behalf of a user during a given federated session, i.e. vouches for the user's identity, whereas a financial service provider like a credit card company may act as a financial home domain by providing electronic funds for online purchase transactions during the same federated session.

The establishment of trust relationships between service providers may occur primarily through out-of-band processes in which the service providers engage in various types of legal agreements with respect to the duties and liabilities of each party. It should be noted that the establishment of a trust relationship between a user and a service provider may be equivalent to a registration process, although a registration process may be only a portion of a larger process that creates a trust relationship. It should also be noted that a registration process may be completely or only partially electronic. For example, a user may be required to submit paper or electronic documents to a service provider from appropriate authorities in order to establish identity or possibly to establish legitimate possession of certain information. Hence, a portion of the registration process may be done in an out-of-band process that occurs significantly prior to the completion of the registration process.

Turning now from a description of typical federated environments to a federated computing environment for supporting the present invention, in brief summary, a federated computing environment facilitates the maintenance of a user's attribute information at one or more locations within a federated environment and also facilitates the subsequent use of the user's attribute information from one of those locations throughout the federated environment. From a certain perspective, this functionality may be described as distributed attribute information storage. A service provider that requires a user's attribute information can identify one of these attribute storage locations and then retrieve the user's attribute information when necessary.

In a federated environment in which the present invention operates, a user can contract with one or more attribute information providers (AIPs). Attribute information providers correspond to entities which store, manage, and retrieve attribute information for other service providers on behalf of specific users. Hence, an attribute information provider is a specialized service provider which manages user attributes as a distinct service in itself. However, it should be noted that the roles of an attribute information provider and some other type of service provider can be implemented within distinct entities or within a single entity.

A user can establish and maintain a trust relationship with one or more attribute information providers such that an attribute information provider can provide the user's attribute information to other service providers within the federated environment as required, i.e. as a service. Other service providers, such as online banks or online merchants, may also maintain a trust relationship with an attribute information provider such that another service provider can trust the attribute information for a user that is provided by the attribute information provider on behalf of the user.

With reference now to FIG. 5C, a block diagram depicts a preferred federated environment in which the present invention may be implemented. Federated environment 540 comprises multiple users and multiple services. The users of the federation are represented by user 542, who interacts with service providers that are inside or outside the federated computing environment through the use of a client device (not shown) in a manner similar to that described in FIG. 1A.

Typical federated service providers are represented by e-commerce service providers in FIG. 5C. In a manner similar to that already described above with respect to FIG. 5B, these e-commerce service providers (ECSPs) may comprise the ability to authenticate both federated and non-federated users through the inclusion of an authentication manager (AM) and its associated databases. In addition, these e-commerce service providers may comprise the ability to manage user attribute information through the inclusion of an attribute information manager (AIM) and its associated databases. In the example shown in FIG. 5C, ECSP 544 comprises AM 546, and ECSP 548 comprises AM 550; hence, these e-commerce service providers do not manage user attribute information. ECSP 552 comprises neither an authentication manager nor an attribute information manager. In contrast, ECSP 554 comprises AM 556 and AIM 558, and ECSP 560 comprises AM 562 and AIM 564, so these e-commerce service providers are able to perform authentication operations and to, manage user attribute information for users, whether those users are considered to be federated users or non-federated users.

ECSPs 544, 548, 552, 554, and 560 are shown in FIG. 5C as participating in federation 540 because they share some type of common functionality based on previously established trust relationships. Although each and every e-commerce service provider does not necessarily have a trust relationship with every other e-commerce service provider, the e-commerce service providers have a framework or network of trust relationships that warrant their inclusion in federation 540. In contrast, ECSP 566 comprises AM 568 and AIM 569 in order to be able to perform authentication operations and to manage user attribute information for users, but ECSP 566 is not included within federation 540 because it does not have any previously established trust relationships with any other service providers within federation 540. In the example of FIG. 5C, user 542 is shown as included within federation 540 because user 542 has at least one trust relationship with at least one service provider within federation 540, although user 542 may interact with federated and non-federated service providers.

The differences between a typical federated computing environment as shown in FIG. 5B and a federated computing environment as shown in FIG. 5C in which the present invention may be deployed are apparent with respect to FIG. 5C, which depicts a set of attribute information providers. As mentioned above, a user can contract with one or more attribute information providers in a federated environment, and the attribute information providers (AIPs) manage user attributes as a distinct service in itself, although this service may be offered in conjunction with other services by single enterprise. Compared with federation 520 in FIG. 5B, federation 540 in FIG. 5C comprises attribute information providers as distinct service providers.

In particular, AIP 570 comprises AM 572 and attribute management unit (AMU) 574. An attribute management unit includes any supporting databases, such as user registry databases (not shown), and it is similar to the attribute information managers that are supported by the federated e-commerce service providers, but an attribute management unit also includes additional functionality for performing the operations of the present invention as described in more detail further below.

Federation 540 also includes AIP 580, which supports AM 582 and AMU 584 in a manner similar to AIP 570. In the example shown in FIG. 5C, user 542 is a registered user of AIP 580, as reflected by the inclusion of information about user 542 in user registry database 586 that is managed by AIP 580. The establishment of a trust relationship between an attribute information provider and a user would be primarily an out-of-band process by which the user registers or subscribes with an attribute information provider that stores, maintains, and releases the user's attribute information. In this example, user 542 has previously contracted with AIP 580 to establish a trust relationship with AIP 580 so that AIP 580 may provide user attribute information to other service providers on behalf of user 542. Likewise, AIP 590 supports AM 592 and AMU 594, which manages user attribute information for user 542 as reflected by that user's registration in user registry database 596.

A user may contract with an attribute information provider for the release of attributes in different contexts. For example, a user might require explicit user approval for the release of certain attribute information, while in other cases, the user may allow attributes to be released without requiring user intervention. These preferences may vary with the identity of the e-commerce service provider that is requesting the release of the user's attributes. An attribute information provider may store these user preferences as an attribute release policy in association with the values of the user attributes within a database that is maintained by the attribute information provider. Hence, an attribute information provider may optionally present an interface for a user to create attribute release policies when a user registers for the attribute information service or when a user updates the user's attribute information.

An e-commerce service provider may have previously established a trust relationship with at least one attribute information provider and possibly a plurality of attribute information providers, which would also be primarily an out-of-band process. An e-commerce service provider may contract for different levels of attribute information services. It should be understood that the present invention is able to interoperate with a variety of underlying attribute dissemination schemes. As part of the process of establishing a trust relationship, the e-commerce service provider and the attribute information provider would engage in an out-of-band exchange of information that is used to establish a trust relationship, which may include a shared secret key, digital certificates, or some other form of information. This information is used to protect user attribute information that is presented to the e-commerce service provider by the attribute information provider during a user transaction.

As shown in the example of FIG. 5C, the user may have previously established a trust relationship with a plurality of attribute information providers. As noted above, a federated service provider may be considered to be a user's home domain for a particular purpose; in other words, a user may have concurrent specialized home domains during a particular federated session, i.e. user session for one or more transactions or operations within a federated computing environment. If the user has registered with multiple attribute information providers, then one of those attribute information providers would be considered to be the user's attribute home domain for a particular federated session. Concurrently, another service provider that is providing authentication assertions on behalf of the user during the same session may be considered to be the user's authentication home domain for that session. The labeling of these different home domains may be formally supported within the federation, although the following examples use these terms more as naming conventions in order to facilitate a description of the operations that occur among many service providers or domains during the processes of the present invention that are described with respect to the remaining figures hereinbelow.

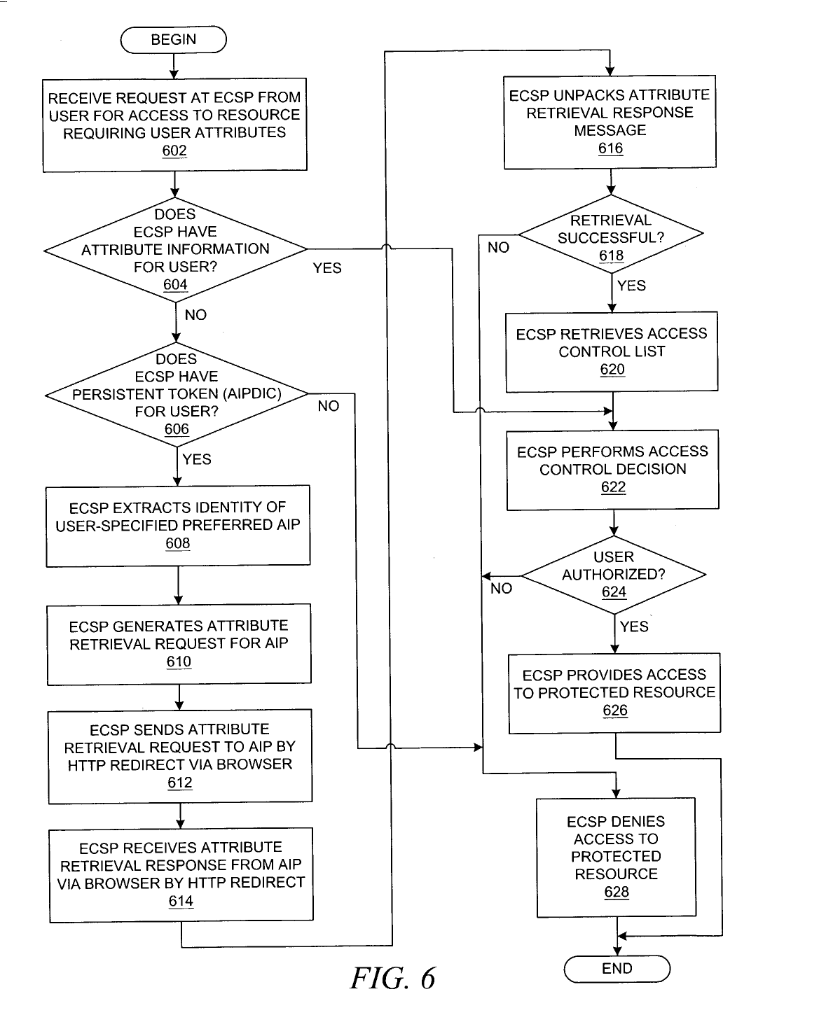

With reference now to FIG. 6, a flowchart depicts a process by which an e-commerce service provider attempts to retrieve attribute information from an attribute information provider for a user who is attempting to access a resource at the e-commerce service provider. FIG. 6 shows a process that is initiated when a user requests access to a resource. In response, an e-commerce service provider decides that user attribute information is required, possibly for an access control decision, for a content personalization operation, or for some other user-specific operation. It may be assumed that the e-commerce service provider authenticates the user or obtains the identity of the user in some trustworthy manner when necessary, e.g., an authentication assertion or through a process such as that shown in FIG. 1C.

In order for the user-specific operation to be performed, the e-commerce service provider requires attribute information for the user. In the present invention, the e-commerce service provider is not required to prompt the user for attribute information, yet the e-commerce service provider may not have direct access to a user attribute information repository nor a dedicated or proprietary attribute information manager, such as those shown in FIG. 5A, that may be storing and maintaining the attribute information. Moreover, the e-commerce service provider desires to minimize the number of information requests that are sent to the user.

Instead, in accordance with the use and advantages of the present invention, the e-commerce service provider attempts to retrieve user attribute information from an attribute information provider that acts in place of a domain's dedicated or proprietary attribute information manager. In accordance with the present invention, a user has an ability to direct the attribute information retrieval operation to one of potentially many attribute information providers.

The process in FIG. 6 begins with an e-commerce service provider receiving a request from a user for access to a resource for which the e-commerce service provider needs to perform a user-specific operation (step 602). As noted above, user-specific operations may include content personalization operations, access control decisions, i.e. authorization decisions, or other types of operations. The following examples depict access control decisions, but it should be understood that the present invention is applicable to a variety of user-specific operations that require user attribute information. For example, a Web page can be customized to include a weather report for the region that corresponds to the user's residence address that is stored as part of the user's attribute information. This step may be necessary only for those situations in which additional attributes are required for a user-specific response; there may be other cases in which the e-commerce service provider does not require such information, e.g., serving non-customized Web pages.

A determination is then made as to whether or not the e-commerce service provider already has attribute information for the user, possibly cached from a previous transaction (step 604). It should also be noted that the methods of the present invention could be implemented along with other methods for handling user attributes, and the operations for different attribute storage methods could be merged in some manner that requires multiple checks for user attribute storage from different locations or services, which could be accommodated at step 604. For example, the e-commerce service provider may maintain user attribute storage for certain customers who have permitted the e-commerce service provider to maintain personal information, possibly instead of and/or in addition to using an attribute information provider.

If the e-commerce service provider does not have attribute information for the user, then the e-commerce service provider determines whether or not it possesses or can retrieve an AIP domain identity token for the user (step 606). The AIP domain identity token for a particular user would contain information that identifies one or more attribute information providers that manage user attribute information for the particular user. Hence, the e-commerce service provider may possess an AIP domain identity token for the user because it may have been received in the form of an HTTP cookie from the user's browser as part of an associated HTTP request. Alternatively, the e-commerce service provider may retrieve the AIP domain identity token for the user from a datastore, such as a server-side user registry database, which implies that the e-commerce service provider has previously authenticated the user to determine the identity of the user.

If the e-commerce service provider determines that it has an AIP domain identity token for the user, then the e-commerce service provider extracts the identity of an attribute information provider from the AIP domain identity token (step 608) and generates an attribute retrieval request message for the indicated attribute information provider (step 610). The attribute retrieval request message indicates a set of user attributes to be retrieved from the indicated attribute information provider. This set of user attributes may be a full set or a subset of user attributes that are required by the e-commerce service provider to complete a response to the resource request from the user. Rather than request a full set of user attributes from only one attribute information provider, the requested e-commerce service provider may optionally determine to use more than one attribute information provider whereby the e-commerce service provider requests a subset of user attributes from each of the multiple attribute information providers.

The e-commerce service provider sends the attribute retrieval request message to the appropriate attribute information provider using HTTP redirection via the user's browser (step 612). An application that is providing the functionality for the e-commerce service provider could be implemented with an event queue such that messages can be sent and received asynchronously; after sending the attribute retrieval request message, the application would not have to wait for the return of a corresponding attribute retrieval response message because the application could perform other actions during this time period.

Given the scenario described with respect to steps 602-612, one can understand the effectiveness of operations within the federation. Although the e-commerce service provider does not already have attribute information for the user, most likely because the user is initiating a new session with the e-commerce service provider, the e-commerce service provider can attempt to obtain attribute information for the user from the user's indicated attribute information provider. Since an AIP-enrollment process already established the identity of an attribute information provider for the user in some manner with the e-commerce service provider through the use of a persistent AIP domain identity token, the user has not been asked to provide the identity of an attribute information provider directly to the e-commerce service provider during this particular session.

The examples of the present invention that are shown in the figures employ HTTP redirection via the user's browser to exchange information between entities, such as an attribute information provider and a requesting e-commerce service provider. However, it should be noted that the present invention may be conducted over a variety of communication protocols and is not meant to be limited to HTTP communications. Moreover, the entities may communicate directly when necessary; messages are not required to be redirected through the user's browser.

Continuing with the example, at some point in time, the e-commerce service provider receives the attribute retrieval response message from the attribute information provider using HTTP redirection via the user's browser (step 614). The e-commerce service provider unpacks the attribute retrieval response message (step 616) and examines it to determine whether the attribute retrieval operation was successfully completed (step 618). If so, then the e-commerce service provider retrieves an access control list (step 620) and initiates the access control decision operation (step 622). A determination is made as to whether or not the user is authorized (step 624), and if the result of the access control decision is positive, i.e. the user is authorized, then the e-commerce service provider provides access to the protected resource (step 626), and the process is complete. If the attribute retrieval operation was not successfully completed at step, 618, then the e-commerce service provider denies access to the protected resource (step 628), and the process is complete.

It should be noted that, in some cases, an e-commerce service provider or other type of domain may have direct access to an attribute information manager that may provide the user's attribute information. For example, a domain may maintain user attribute information for many users in server-side storage. Referring again to step 604, if the e-commerce service provider already has attribute information for the user, then the process branches to step 622 in which the e-commerce service provider immediately performs an access control decision. This scenario may also occur, for example, when the user has already accessed the same or a similar controlled resource at the e-commerce service provider, after which the e-commerce service provider may have cached the user's attribute information.

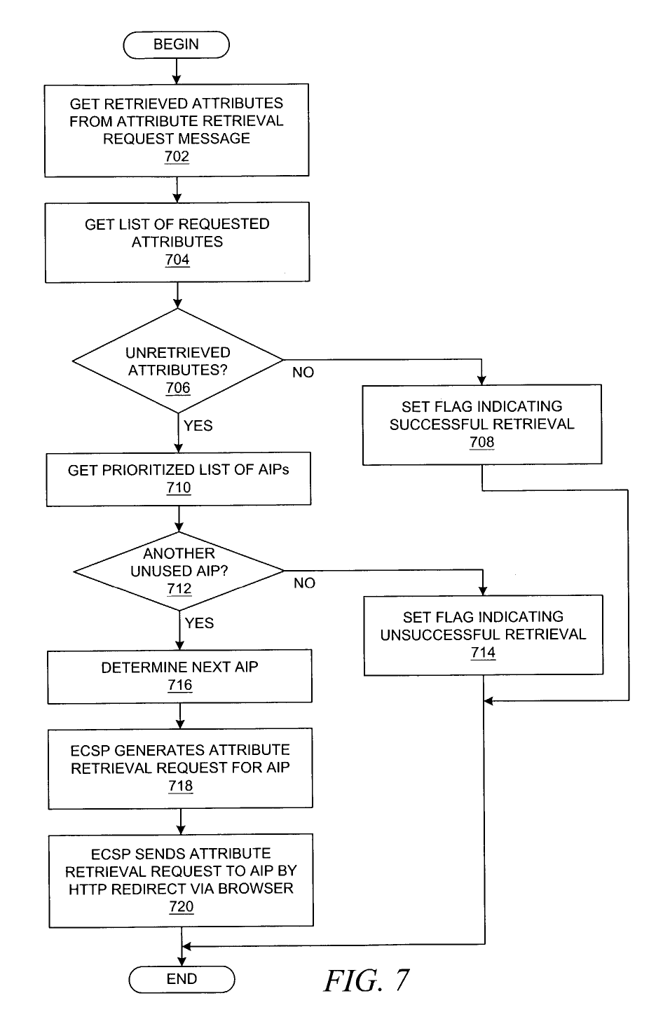

It should also be noted that FIG. 6 depicts the use of a single attribute information provider. However, the framework of the federation may be implemented to support the use of multiple user-specified attribute information providers, as explained in more detail further below with respect to FIG. 7.

FIG. 6 illustrates how a user may attempt to access a resource at an e-commerce service provider and how the e-commerce service provider may need user attribute information to perform a user-specific operation. Referring again to step 606, the e-commerce service provider determines whether it has a persistent AIP domain identity token for the user. The AIP domain identity token contains identity information for an attribute information provider that can retrieve user attribute information in response to a request from the e-commerce service provider. The e-commerce service provider might possess an AIP domain identity token for the user, such as a persistent HTTP cookie, because one could have been previously established through an AIP-enrollment operation. However, if the e-commerce service provider does not have an AIP domain identity token for the user, then the e-commerce service provider may deny access to the requested resource at step 628.

It should be noted that it is possible for the e-commerce service provider to independently interact with the user while also implementing the present invention, such as authenticating the user and prompting the user to provide information about the identity of any attribute information providers at which the user stores his/her attribute information or prompting the user to provide the required attribute information directly to the e-commerce service provider at step 604. However, these actions would not have the advantages that are provided through the present invention. A goal of the present invention is to allow the user to act within a federated environment more efficiently by having to overcome fewer information barriers. Hence, it is preferable within the federated environment for an e-commerce service provider to be able to rely on the existence of an AIP domain identity token; information about the identity of any attribute information providers at which the user stores his/her attribute information can be obtained from the persistent AIP domain identity token, thereby reducing the burdens on the user to provide the information.

However, before an e-commerce service provider may rely on the existence of a persistent AIP domain identity token to provide the identity of an attribute information provider from which to retrieve a user's attribute information, the AIP domain identity token must be established in some manner, such as pre-establishing this information via AIP-enrollment operations. A user may enroll the identity of a user's attribute information provider at a given e-commerce service provider, which then stores the information in an AIP domain identity token that will be available to the e-commerce service provider. The establishment of an AIP domain identity token can be established through many different processes, particularly AIP-enrollment processes in which the user approves of the persistent storage of the user's AIP information, i.e. identifiers for the attribute information providers that are managing the user's attribute information on behalf of the user. These enrollment processes are described in more detail in U.S. patent application Ser. No. ______ (Attorney Docket Number AUS920020387US1), filed ______ (TBD), titled “Method and system for user enrollment of user attribute storage in a federated environment”.

With reference now to FIG. 7, a flowchart depicts a subprocess by which an e-commerce service provider attempts to retrieve attribute information from multiple prioritized attribute information providers for a user who is attempting to access a resource at the e-commerce service provider. FIG. 7 depicts a subprocess that may be performed in conjunction with the process that is shown in FIG. 6. Step 618 in FIG. 6 examines the response message that has been returned by an attribute information provider in order to determine whether the attribute retrieval operation was successfully completed. In this manner, the process that is shown in FIG. 6 takes an all-or-none approach. This all-or-none approach in evaluating the retrieval operation may be useful in some environments. However, an attribute information provider may return various status codes that indicate a range of success in obtaining the requested attributes. Hence, the e-commerce service provider can review whether any attributes have been successfully retrieved and then determine its next action, as explained in more detail with respect to FIG. 7.

Referring to FIG. 7, after the e-commerce service provider has received and examined an attribute retrieval request message from an attribute information provider, e.g., as shown in steps 614 and 616 in FIG. 6, the e-commerce service provider gets a list of zero or more retrieved attributes from the attribute retrieval request message (step 702). After reading the list of attributes that were previously requested by the e-commerce service provider (step 704), the list of requested attributes and the list of retrieved attributes are compared to determine if there were any attributes that were not successfully retrieved (step 706). Alternatively, the e-commerce service provider may be able to make this determination solely from the information that was returned by the attribute information provider within the attribute retrieval request message.

If there were no unretrieved attributes at step 706, i.e. all of the requested attributes were retrieved by the most recently contacted attribute information provider, then a processing flag is set to indicate that the attribute retrieval operation was successful (step 708), and the subprocess is complete. In this case, there is no need to contact another attribute information provider because the e-commerce service provider has all of the attributes that it requires for its user-specific operation.

If there are some attributes that have not been retrieved, the e-commerce service provider does not necessarily have to fail the attribute retrieval operation for the current transaction. The process that is shown in FIG. 6 was described above as if the e-commerce service provider could only contact one attribute information provider to retrieve the attributes for the user. However, there may be multiple attribute information providers that are associated with the user who initiated the original resource request. At steps 606 and 608 in FIG. 6, rather than the persistent AIP domain identity token only containing the identity of a single preferred attribute information provider, the AIP domain identity token may contain a prioritized list of multiple preferred attribute information providers. In other words, after the e-commerce service provider has attempted to retrieve attributes from a single attribute information provider, the e-commerce service provider may have additional attribute information providers from which it may attempt to retrieve the user's attribute information.

Hence, if there are some attributes that have not yet been retrieved, then the e-commerce service provider gets the prioritized list of attribute information providers for the user (step 710). A determination is made as to whether or not there are any other attribute information providers that have not yet been contacted to retrieve the user's attribute information (step 712). If not, then a processing flag is set to indicate that the attribute retrieval operation was unsuccessful (step 714), and the subprocess is complete. In this case, the e-commerce service provider cannot contact another attribute information provider because the e-commerce service provider has already contacted all of the attribute information providers that are associated with the user.

If there is at least one attribute information provider that has not yet been used in an attempt to retrieve the attributes, then the e-commerce service provider gets the name or identity of the next attribute information provider in the list (step 716). In a manner similar to that shown in steps 612 and 614 in FIG. 6, the e-commerce service provider generates an attribute retrieval request message that contains the names of the attributes that have not yet been retrieved (step 718) and sends the message to the appropriate attribute information provider by HTTP redirection via the user's browser (step 720), thereby completing the subprocess temporarily. Using a list of attribute information providers, the subprocess that is shown in FIG. 7 may be invoked multiple times; in this manner, the subprocess that is shown in FIG. 7 may be viewed as being an extension to the processing that is performed between steps 616 and 618 in FIG. 6.

In most scenarios, the list of user attributes that was most recently requested by the e-commerce service provider is most likely the list of attributes that is required by the e-commerce service provider to complete a requested transaction or user-specific operation. However, as noted above, the e-commerce service provider may have determined to request only a subset of the user attributes that are required to respond to the user's resource request. If the e-commerce service provider has previously determined to use more than one attribute information provider, then the e-commerce service provider would continue to retrieve unrequested user attributes from other attribute information providers. In other words, even if an attribute information provider returns all of the requested attributes, there may be additional attributes that are unretrieved. The e-commerce service provider would subsequently add all or a subset of the unrequested user attributes to the list of attributes that have not yet been retrieved. In this manner, the e-commerce service provider does not necessarily request all unretrieved attributes in the next attribute retrieval request message.

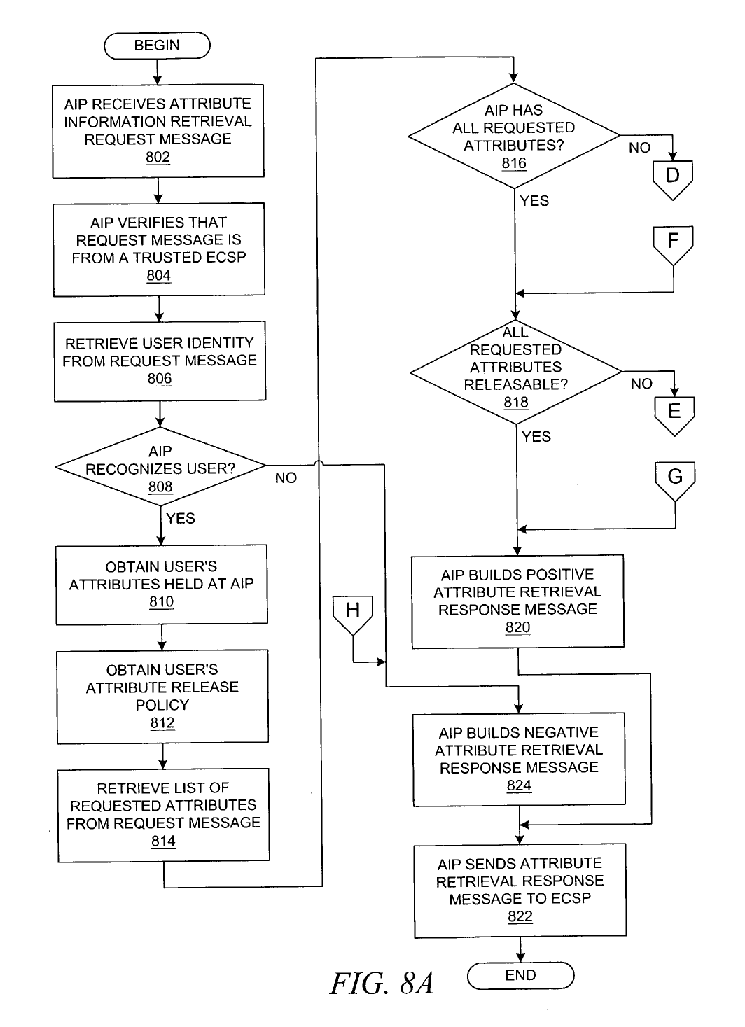

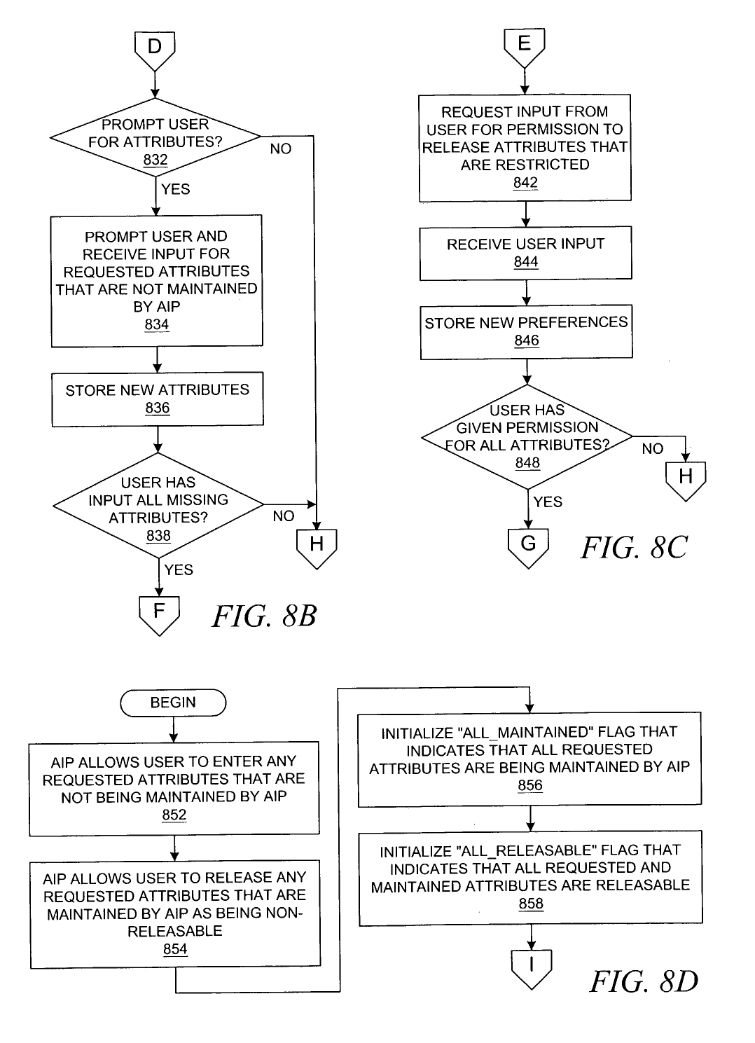

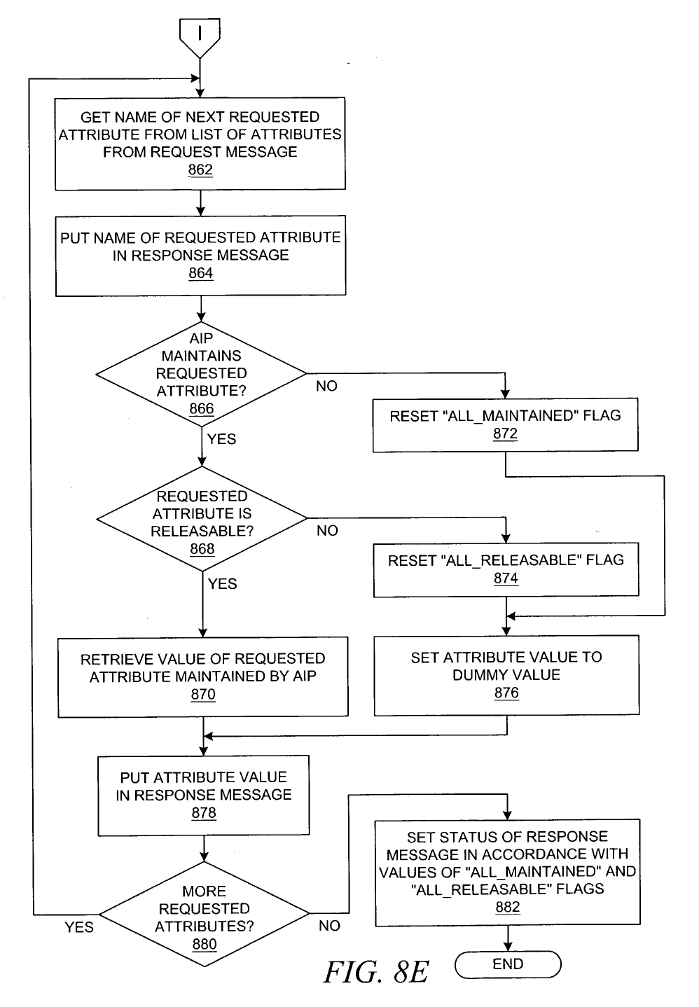

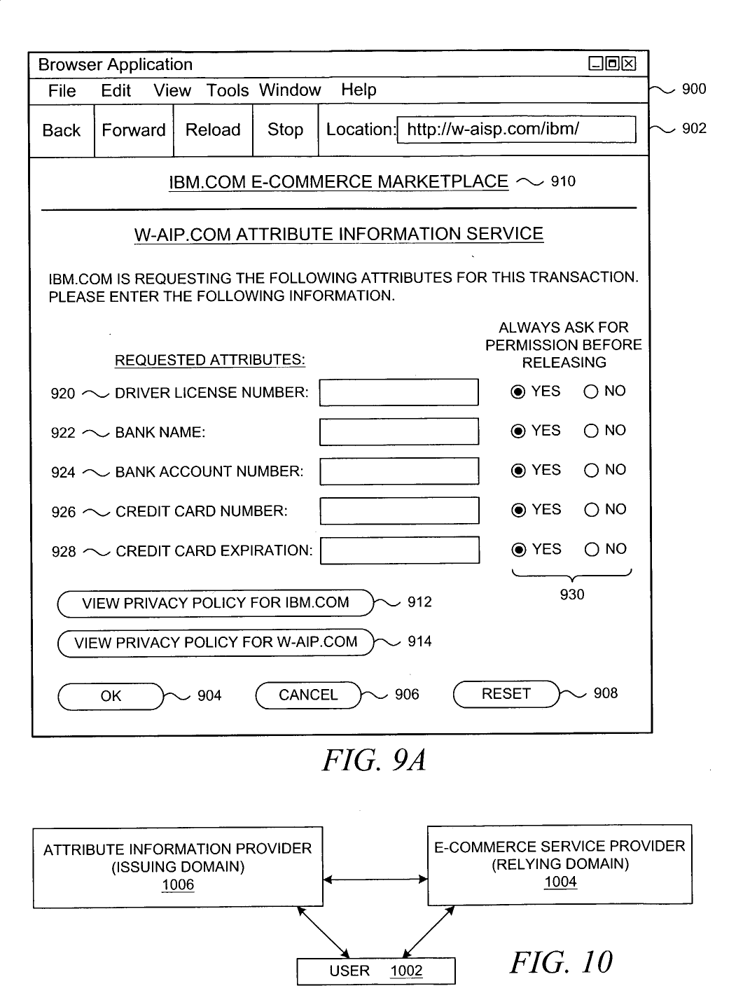

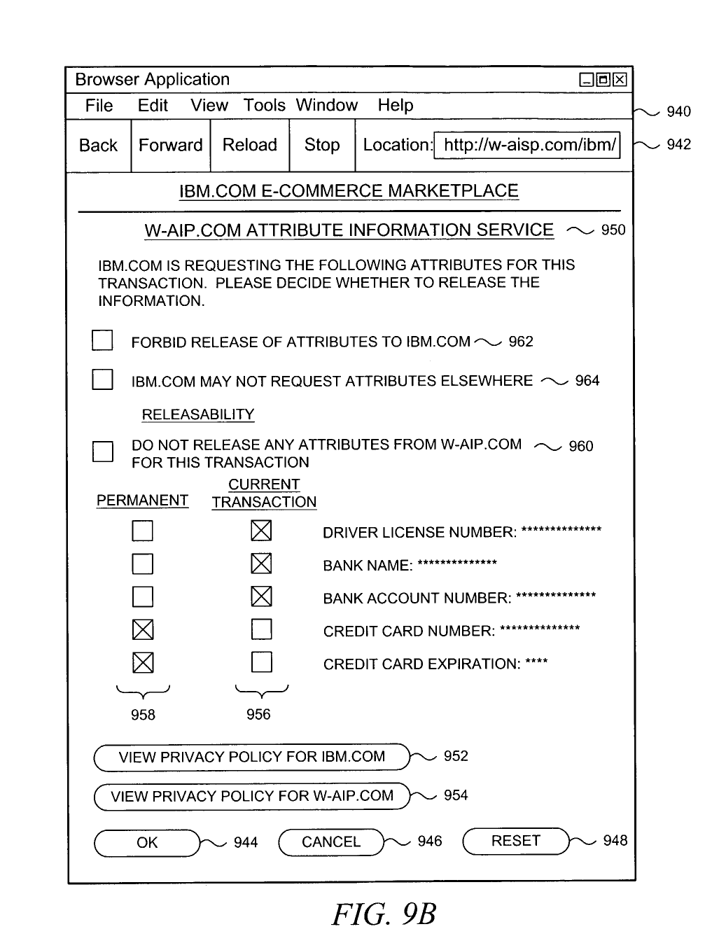

The present invention may be implemented within a preferred federated environment as described with respect to FIGS. 5C-7 above. FIG. 5C shows a preferred federated environment, and FIG. 6 and FIG. 7 depict preferred processes for retrieving attribute information from either one or multiple attribute information providers when a user initiates a transaction at the e-commerce service provider. FIGS. 8A-9B depict processes for allowing a user to control dissemination of the user's attribute information.

In particular, after a user has initiated a transaction at an e-commerce service provider, the e-commerce service provider obtains an identifier of an attribute information provider for the user that is initiating the transaction, e.g., via an AIP domain identity token for the user, if the e-commerce service provider requires user attribute information to complete the transaction. The e-commerce service provider sends a request to the attribute information provider to retrieve the user's attribute information.

However, during the retrieval of the user's attribute information, various processing options may present themselves, and the attribute information provider may require direct communication with the user. For example, an attribute information provider may support policies in which a user must confirm the release of certain information. As another example, the attribute information provider may determine that it is not currently storing the requested user attribute information for the user. The present invention supports a processing environment in which an attribute information provider may directly communicate with the user during a transaction prior to responding to the request from the e-commerce service provider, as described in more detail below.

With reference now to FIGS. 8A-8C, a set of flowcharts depicts a process by which an attribute information provider determines whether or not it should provide attribute information for a user at the request of an e-commerce service provider. The flowcharts in FIGS. 8A-8C show a set of processes that may occur at the attribute information provider when an e-commerce service provider sends an attribute retrieval request message to the attribute information provider as described above in FIG. 6.

Referring to FIG. 8A, the process begins when an attribute information provider receives an attribute retrieval request message from an e-commerce service provider for a given user via HTTP redirection through the user's browser (step 802). The attribute information provider verifies that the attribute retrieval request message is from a federated or trusted e-commerce service provider (step 804). If not, then the attribute information provider may ignore the message or return an error message.

A user identity is retrieved from the attribute retrieval request message (step 806), and a determination is made as to whether or not the user is recognized by the attribute information provider (step 808). The e-commerce service provider and the attribute information provider may be able to exchange and interpret a user's identity based on a common identity management scheme within a federation.

If the user is not recognized, then the process branches and returns an error message. If the user identity is recognized, then the attribute information provider maintains some type of user account or user profile for the identified user. The identified user's attributes are retrieved from a database maintained by the attribute information provider (step 810), preferably along with the identified user's attribute release policy (step 812); in other embodiments, the management of attributes may not be restricted through release policies. The list of requested attributes is obtained from the attribute retrieval request message (step 814), and the attribute information provider can then begin to determine whether or not any attributes should be returned in response to the request from the e-commerce service provider.

A determination is made about whether or not the attribute information provider is currently maintaining all of the user attributes that were requested by the e-commerce service provider (step 816). If not, the process branches to the subprocess shown in FIG. 8B. If the attribute information provider is currently maintaining all of the user attributes that were requested by the e-commerce service provider, then a determination is made about whether or not all of the user attributes are releasable by the attribute information provider to the e-commerce service provider (step 818). If not, the process branches to the subprocess shown in FIG. 8C. If all of the user attributes are releasable by the attribute information provider to the e-commerce service provider, then the attribute information provider has determined that it has all of the requested attributes and that all of the user attributes are releasable to the e-commerce service provider. Hence, the attribute information provider builds a positive attribute retrieval response message containing the requested user attributes (step 820) and sends the attribute retrieval response message to the e-commerce service provider via HTTP redirection through the user's browser (step 822), thereby completing the process.

It should be noted that other methods may be employed to return the attributes from the attribute information provider to the requesting e-commerce service provider. For example, rather than returning copies of the attributes within an attribute retrieval response message, the attribute information provider may return a message that contains only a pointer to the attributes in the form of a resource name or resource identifier; the e-commerce service provider would use the pointer to retrieve the attributes. The pointer could be securely transmitted between the attribute information provider and the e-commerce service provider through mutually authenticated SSL to protect the pointer from unwanted disclosure, thereby ensuring that only the e-commerce service provider is able to use the pointer. The method of returning only a pointer is particularly useful if large amounts of user attribute information must be transmitted and there are communication protocol constraints that limit the amount of data that can be transmitted at any one time.

Referring again to step 808, if the user identity in the attribute retrieval request message was not recognized by the attribute information provider, then the attribute information provider builds a negative attribute retrieval response message (step 824) and sends the attribute retrieval response message to the e-commerce service provider via HTTP redirection through the user's browser at step 822. The use of the terms “positive response” and “negative response” are relative, and as explained in more detail further below, the present invention supports a range of partial responses and various types of returned status.

At step 816, if the attribute information provider is not currently maintaining all of the user attributes that were requested by the e-commerce service provider, then the process branches to FIG. 8B.

Referring to FIG. 8B, the attribute information provider may request input from the user to provide user attribute information for the requested attributes that the attribute information provider is not currently maintaining.

A determination is made as to whether or not the attribute information provider should prompt the user for attribute information (step 832). If not, then the process branches back to step 824 in FIG. 8A to return a negative attribute retrieval response message.

The decision as to whether or not to prompt the user may be completed in accordance with one or more processing flags that are available to the attribute information provider. For example, when a user's account is set up at the attribute information provider, such as when a user registers for the service, the user may have been presented with an option that indicates whether or not the attribute information provider should prompt the user at the appropriate time for any attribute information that is not currently maintained by the attribute information provider.

This type of option is advantageous for the following reasons. As depicted in FIG. 8B, when an attribute information provider is retrieving the user's attribute information at the request of an e-commerce service provider, there may be many occasions when the attribute information provider discovers that it is not maintaining certain user attribute information, thereby generating many user prompts. Over time, it may be expected that such occasions would diminish as more information is managed by the attribute information provider.

However, if the user manages his or her user attribute information at multiple attribute information providers, there may be many such occasions across many attribute information providers. Over time, the user may become aggravated with responding to many prompts for user attribute information.

With the availability of an option that indicates that the attribute information provider should prompt the user for missing attribute information, the user might select this option if the user considers the attribute information provider to be the user's primary attribute information provider among a set of attribute information providers. If this option is selected by the user, then it may be expected that the attribute information provider would eventually maintain much or all of the user's attribute information, although the user has the choice as to what user attribute information is given to the attribute information provider. This expectation is reasonable because the user would be repeatedly prompted to provide user attribute information whenever necessary.

However, the user might decline this option if the user considers the attribute information provider to be a less important attribute information provider, thereby limiting storage of certain attribute information at particular attribute information providers. In addition, the user might decline this option to limit the number of times that the user would be prompted for the information by different attribute information providers, i.e. to reduce the amount of nuisance prompting.

As another example of the manner in which the attribute information provider may employ a processing flag with respect to prompting the user, the e-commerce service provider that originated the attribute information retrieval message could set a flag within the message to inform the attribute information provider whether it should prompt the user. Since the e-commerce service provider should know whether or not it will contact other attribute information providers while attempting to retrieve a particular user's attribute information, the e-commerce service provider can inform the attribute information provider whether or not to prompt the user for any attributes that the attribute information provider is not currently maintaining. For example, the e-commerce service provider might set this flag when the e-commerce service provider is sending an attribute retrieval request message to the last attribute information provider in the set of multiple attribute information providers for the user. In this manner, the last attribute information provider in the set would prompt the user as a last resort to obtain the attribute information that might be required to complete a given transaction.

Alternatively, the e-commerce service provider could set a flag within the attribute information retrieval message that indicates that the attribute information provider that receives the message is the last attribute information provider that will be contacted by the e-commerce service provider. In this case, the attribute information provider is not being told to prompt the user. Instead, the attribute information provider may use the flag as part of its own determination as to whether or not to prompt the user. Other optional flags could also be included in messages between the e-commerce service provider and an attribute information provider.

Referring again to FIG. 8B, if the attribute information provider should prompt the user for additional attribute information, then after requesting and receiving user input (step 834) and storing any newly provided user attribute information (step 836), a determination is made as to whether or not the attribute information provider now has all of the user attributes that were requested by the e-commerce service provider (step 838). In other words, the user may have refused to provide some of the user attribute information. If the attribute information provider has all of the requested attributes, then the process branches back to step 818 in FIG. 8A to determine whether the attributes may be released. If the attribute information provider does not have all of the requested attributes, then the process branches back to step 824 in FIG. 8A to return a negative attribute retrieval response message.

Referring again to FIG. 8A, if not all of the attribute information is releasable at step 818, then the process branches to FIG. 8C.

Referring to FIG. 8C, the attribute information provider requests input from the user to indicate permission for the attribute information provider to release any requested attributes that have release restrictions (step 842). In other words, the attribute information provider asks the user whether or not the user wants to release any attributes that were requested by the e-commerce service provider and that the user previously restricted, possibly through the user of an attribute release policy. After receiving user input (step 844) and storing any modified restrictions or permissions for the attributes (step 846), the attribute information provider determines whether the user has permitted the release of all of the requested attributes (step 848). If so, then the process branches back to step 820 in FIG. 8A to return a positive attribute retrieval response message, and if not, then the process branches back to step 824 in FIG. 8A to return a negative attribute retrieval response message.

As shown in FIGS. 8A-8C, at some point in time, the attribute information provider constructs and returns a response message to an e-commerce service provider, as described with respect to steps 820-824 in FIG. 8A. The processes that are shown in FIGS. 8A-8C operate as if the attribute information provider either successfully returns all of the requested attributes or fails. For example, a positive response message is generated at step 820 only if the attribute information provider has all of the requested attributes and only if the attribute information provider can release all of the requested attributes. In all other cases, a negative response message is generated at step 824.

This all-or-none approach in reporting the status of the retrieval operation may be useful in some implementations of the present invention. In other implementations of the present invention, the attribute information provider may return various status codes that indicate a range of success in obtaining the requested attributes. For example, various positive status codes may be returned even if the attribute information provider has been able to retrieve only some of the requested attributes. A status code for complete failure might be used if the attribute information provider does not maintain any of the requested attributes or if the attribute information provider cannot release any of the requested attributes that it does maintain. After the requesting e-commerce service provider receives the response message, the e-commerce service provider can review whether any attributes have been successfully retrieved and then determine its next action, such as attempting to obtain the remaining attributes, as described above with respect to FIG. 7. FIGS. 8D-8E depict an example of a process that might be used by an attribute information provider to report partial success in retrieving attributes.

The present invention may be implemented independently from any particular format of the request messages and response messages. The positive and negative attribute retrieval response messages may have similar data structures. The response messages may be encrypted to protect the user's attribute information. It should also be noted that, in both cases, the attribute information provider may insert dummy information or otherwise mask the contents of the response message in order to prevent a snooper from being able to differentiate successful and unsuccessful responses; for example, a series of intercepted unsuccessful messages may still provide information about the system's ability to obtain attribute information.

With reference now to FIGS. 8D-8E, a set of flowcharts depict a subprocess by which an attribute information provider generates a response message to be sent to an e-commerce service provider that has requested the retrieval of attributes for a particular user. The subprocess that is shown in FIGS. 8D-8E may be used to generate a response message that returns only some of the attributes that have been requested by an e-commerce service provider. Hence, the subprocess that is shown in FIGS. 8D-8E may be used instead of FIGS. 8B-8C and steps 816-820 and 824 in FIG. 8A. It should be noted, however, that the processes in the flowcharts are only examples of the present invention and should not be interpreted as exclusive embodiments.

Referring to FIG. 8D, the subprocess begins by allowing the user to enter any requested attributes that are not currently being maintained by the attribute information provider (step 852). The subprocess continues by allowing the user to select options that release any requested attributes that are being maintained by the attribute information provider as non-releasable attributes (step 854), e.g., attributes that require explicit approval by the user before the attributes can be released as indicated in an attribute release policy. Steps 852 and 854 essentially repeat the functionality shown in FIG. 8B and FIG. 8C.

As the response message is being generated, a set of processing flags can be used to track the progress in obtaining the requested attributes. In this example, two processing flags are used: an “ALL_MAINTAINED” flag is initialized (step 856) to track whether the attribute information provider has all of the requested attributes, and an “ALL_RELEASABLE” flag is initialized (step 858) to track whether the attribute information provider can release all of the requested attributes.

The subprocess then loops through the list of requested attributes that have been retrieved from the attribute retrieval request message at step 814 in FIG. 8A. The name of the next requested attribute that should be processed is read from the list (step 862), and although the attributes might not be required to be processed in any particular order, the name of the attribute is written into the response message (step 864). A determination is then made as to whether the attribute information provider maintains the attribute (step 866). If so, then a determination is made as to whether the attribute information provider can release the requested attribute (step 868). If so, then the value of the attribute is retrieved (step 870).

If the attribute information provider does not have a requested attribute at step 866, then the “ALL_MAINTAINED” flag is reset (step 872). If the attribute information provider cannot release a requested attribute at step 868, then the “ALL_RELEASABLE” flag is reset (step 874). In either of these cases, a dummy value is assigned to the requested attribute (step 876).

The attribute value or the assigned dummy value is then written into the response message (step 878). A determination is made as to whether there are more attributes in the list of requested attributes that have not yet been processed (step 880), and if so, then the subprocess branches back to step 862 to obtain the next requested attribute.

If there are no more unprocessed attributes in the list, then the status of the response message is set in accordance with the values of the processing flags (step 882). For example, if either the “ALL_MAINTAINED” flag or the “ALL_RELEASABLE” flag are not set, then at least one attribute has not been retrieved as requested, and an appropriate status code can be chosen for the response message. The subprocess is then complete, after which it may branch back to the main process to send the response message to the e-commerce service provider.

With reference now to FIG. 9A, a graphical user interface window is presented to a user by an attribute information provider that is requesting the user to input user attribute information that will be used by an e-commerce service provider within a federated environment. Window 900 is a typical browser application window that a user would have previously used to request a resource from the e-commerce service provider, i.e. to initiate some type of transaction with the e-commerce service provider. In most Web environments, the controls that are shown in window 900 would likely be presented in the form of an HTML-formatted document, i.e. Web page, that can be presented by a browser application that is executing on a client device that is being operated by the user. Toolbar 902 contains typical controls for use within the browser application window. OK Button 904 allows a user to indicate that the user has completed the input operation, while CANCEL button 906 allows a user to cancel the pending transaction. Reset button 908 allows a user to quickly return to default values or to clear all of the input fields.

The user may see the name of the e-commerce service provider at the top 910 of the content area in window 900, which allows the user to view which service provider is completing a pending transaction. In the example shown in FIG. 9A, the attribute information provider has attempted to maintain a continuous look-and-feel throughout all of the graphical user interfaces that are seen by the user during the pending transaction. Hence, area 910 of the content area of window 900 may contains the same information that may have been seen by the user in Web pages that were presented by the e-commerce service provider at which the user is completing a transaction. This reminds the user that the e-commerce service provider is controlling the pending transaction, even though the attribute information provider has intervened temporarily to manage the user's attribute information as part of the pending transaction. In a Web browser environment, the attribute information provider could use a set of frames within an HTML document to create this appearance.

The user may want to see any pertinent privacy policies before entering or releasing user information in order to make an informed decision as to whether or not the user truly wishes to complete the pending transaction. Button 912 allows a user to view or review the privacy policy of the e-commerce service provider, while button 914 allows a user to view or review the privacy policy of the attribute information provider.

Window 900 may be presented to a user when an attribute information provider determines that it does not already have one or more attributes that are being requested by an e-commerce service provider, as described above with respect to FIG. 8B. Input fields 920-928 allow the user to input values for the requested attributes. Pairs of radio buttons 930 are associated with the input fields. Each pair of YES/NO radio buttons allows a user to specify whether a user should be prompted during future transactions for permission to release a particular attribute, thereby allowing the user to control when the attribute information provider actually releases the attribute. In alternative embodiments, other permission restrictions could be provided.

After the user attribute information is entered, the attribute information provider stores the values of the attributes so that they are available for subsequent transactions. Following the previous examples, the requested information will eventually be used for an authorization operation at the e-commerce service provider at which the user has a pending transaction.

With reference now to FIG. 9B, a graphical user interface window is presented to a user by an attribute information provider that is requesting the user to release user attribute information that will be used by an e-commerce service provider within a federated environment. In a manner similar to window 900 that is shown in FIG. 9A, window 940 is a typical browser application window that a user would have used to request a resource from the e-commerce service provider. Toolbar 942 contains typical controls for use within the browser application window.

OK Button 944 allows a user to indicate that the user's input is complete, while CANCEL button 946 allows a user to cancel the pending transaction. Reset button 948 allows a user to quickly return to default values or to clear all of the input fields.

In a manner similar to that described above for FIG. 9A, the attribute information provider has attempted to maintain a continuous look-and-feel throughout all of the graphical user interfaces that are seen by the user during the pending transaction. Hence, area 950 of the content area of window 940 also contains the same information as was seen by the user in window 900.

In a manner similar to that described with respect to FIG. 9A, the user may want to see any pertinent privacy policies before entering or releasing user information in order to make an informed decision as to whether or not the user truly wishes to complete the pending transaction. Button 952 allows a user to view or review the privacy policy of the e-commerce service provider, while button 954 allows a user to view or review the privacy policy of the attribute information provider.

Window 940 may be presented to a user when an attribute information provider determines that one or more attributes that are being requested by an e-commerce service provider are not releasable, as described above with respect to FIG. 8C. Although the present invention allows an attribute information provider to support a variety of restrictions, the attributes may be restricted by the user such that they can only be released after explicit authorization by the user, e.g., as indicated through the use of YES/NO radio buttons in FIG. 9A.

In addition, the user interface could provide multiple temporal restraints for each attribute, e.g., one option indicates whether the attribute is to be released for the pending transaction, and another option that indicates whether the attribute is to be permanently releasable. In the example in FIG. 9B, check boxes 956 allow the user to explicitly indicate whether the requested attributes are to be released to the e-commerce service provider for the currently pending transaction, whereas check boxes 958 allow the user to explicitly indicate whether the requested attributes are to be permanently releasable. As another alternative, the attribute information provider could associate the user's selections with a particular e-commerce service provider such that the restrictions are only applied to transactions from a particular domain. Alternatively, the attribute information provider could allow the user to manage all of the user's attributes and associated options each time that the user is presented with the need to input or change some of the attribute information.

The attribute information provider may allow the user to specify other options with respect to the releasability of the user's attribute information. For example, check box 960 allows a user to specify that no attributes should be released from the attribute information provider for the pending transaction; selection of check box 960 would disable check boxes 956 and possibly also check boxes 958.

Check box 962 allows a user to indicate that the user does not want the requested attributes to be released to the requesting e-commerce service provider at all. Alternatively, the user could be provided with an ability to specify general domain restraints, e.g., identifiers or domain names of other e-commerce service providers for which the user wishes to restrict the release of attributes.

Check box 964 allows a user to indicate that the user does not want the requesting e-commerce service provider to attempt to find the user's attribute information through any other sources, e.g., attribute information providers other than the one that is currently requesting input from the user, as might occur in the process shown in FIG. 7.

The selection of check box 962 or check box 964 may be communicated back to the requesting e-commerce service provider in some manner, e.g., through a status code or a control flag in an attribute retrieval response message. Given that the requesting e-commerce service provider preferably operates in a federated environment in cooperation with other entities in the federated environment, the e-commerce service provider would be expected to adhere to the implications of the user's choice, thereby preventing the e-commerce service provider from contacting other attribute information providers to obtain the required attribute information for the pending transaction. If the user selects check box 962, then it would be expected that the user has essentially canceled the pending transaction because the requesting e-commerce service provider will not receive any of the required attributes. If the user selects check box 964, then it would be expected that the pending transaction may fail if the requesting e-commerce service provider does not receive the required attributes from the attribute information provider that is currently requesting input from the user. Check box 964 also has the advantage of reducing the amount of nuisance prompting that the user may experience from other “downstream” attribute information providers that could have been contacted by the e-commerce service provider.

As mentioned above, an attribute information provider may return various status codes or flags to the requesting e-commerce service provider. These codes may include processing options that were stored by the attribute information provider, or that were chosen by a user when the attribute information provider presented a user interface to the user to obtain user input. Referring again to FIG. 7, the flowchart illustrates a process by which an e-commerce service provider attempts to retrieve all of the attributes that are required for a pending transaction. The process shown in FIG. 7 would be expanded to handle the codes or flags that might be returned in an attribute retrieval response message.

For example, if the user selected check box 964, then the attribute information provider would set a particular restriction flag in the attribute retrieval response message. This particular restriction flag would indicate that the e-commerce service provider should not continue contacting other attribute information providers as shown in FIG. 7, after which the e-commerce service provider would continue processing the transaction as necessary, which may include failing the transaction. Other conditions, restrictions, or controls could be presented to the user and communicated back to the e-commerce service provider, which should tailor its processing in accordance with each control flag that it receives from the attribute information provider.

After the user selections are entered in window 940 in FIG. 9B, the attribute information provider stores the releasable indications, if necessary, so that they are available for subsequent transactions. If the user does not release one or more of the requested attributes, then the pending transaction may fail. Attribute information may be masked to prevent inappropriate disclosure.

Referring again to FIGS. 8B-8E, an attribute information provider may provide a user with an opportunity to input attributes and associated options, e.g., through the user interfaces that are shown in FIG. 9A and FIG. 9B. However, if the e-commerce service provider has a prioritized list of multiple attribute information providers, then the e-commerce service provider may contact a series of attribute information providers to retrieve the user's attribute information. In this case, it may be inappropriate for the attribute information provider to present the user interfaces that are shown in FIG. 9A and FIG. 9B because the e-commerce service provider has the opportunity to retrieve the user's attribute information elsewhere.

For example, if the user has attribute information stored in multiple attribute information providers, then the user may become confused during the following scenario. The user has previously selected a permanent list of prioritized attribute information providers, and the user knows that any user attribute that might be required for an online transaction is stored somewhere among the set of selected attribute information storage providers. When the e-commerce service provider sends an attribute retrieval request message to the first attribute information provider, the first attribute information provider presents a user interface for the user to input the attribute information that is not currently maintained by the first attribute information provider, and the user becomes confused and/or worried that the required attribute information was not retrieved from another attribute information provider that maintains the required information. In this scenario, the first attribute information provider has not provided the e-commerce service provider with the opportunity to contact another attribute information provider prior to prompting the user to enter the attribute information.

To avoid such scenarios, the e-commerce service provider may include a flag in the attribute retrieval request message that indicates whether or not the attribute information provider that receives the request message should prompt the user for the required information. In this manner, the e-commerce service provider may loop through a list of prioritized attribute information providers, as described above with respect to FIG. 7, while indicating that the attribute information providers should not prompt the user for any attributes that are not maintained by the attribute information provider or which the attribute information provider determines are not releasable. Rather than failing the attribute retrieval operation after contacting all of the attribute information providers, the e-commerce service provider may make another pass through the set of attribute information providers. In other words, the e-commerce service provider may send another attribute retrieval request message to the first attribute information provider and indicate that the attribute information provider should prompt the user for any attributes that are not maintained by the attribute information provider or which the attribute information provider determines are not releasable. In this manner, all of the attribute information providers are contacted prior to prompting the user for additional information as shown in FIG. 9A and FIG. 9B.

When multiple attribute information providers are supported, the entities in a federated environment may have policies that guide or determine the manner in which an entity should act in such an environment. Whether or not multiple attribute information providers are supported, the entities in a federated environment may have policies that guide or determine when a user should be prompted for information. Various constraints may be contained in a privacy policy for an attribute information provider or e-commerce service provider, or various constraints may be contained in contracts that were established when the entities entered into trusted business relationships with other entities. In other words, the options that were described as being selectable by a user may be administratively configured by the service providers, particularly in view of one or more common policies that are maintained by service providers or that are required to be enforced as part of membership within a federation.

User-Determined Attribute Storage Within Federated Environment in Conjunction with Trust Proxies

As mentioned above, a user can establish and maintain a trust relationship with one or more attribute information providers such that an attribute information provider can provide the user's attribute information to other service providers within the federated environment as required, i.e. as a service. An e-commerce service provider that is being used by the user, such as an online bank or an online merchant, may also maintain a trust relationship with an attribute information provider such that this service provider can trust the attribute information for the user that is provided by the attribute information provider on behalf of the user. This service provider may have previously established a trust relationship with the attribute information provider through an out-of-band process. The descriptions of FIG. 5C and FIG. 6 assume that an e-commerce service provider has previously established a trust relationship with one of the depicted attribute information providers.

However, an e-commerce service providers and an attribute information provider may support the federated architecture as described with respect to FIGS. 2A-4. In other words, the e-commerce service provider and the attribute information provider may act as enterprises or federated domains within the federated environment that is described with respect to FIGS. 2A-4. Rather than establishing a trust relationship with each other directly, the e-commerce service provider and the attribute information provider are members of a federation, and their membership within the federation requires that they have an agreement to participate in the federation by operating in a particular trustworthy manner. Even though the e-commerce service provider and the attribute information provider have not previously established an explicit trust relationship with one another, they have can use trust proxies and trust brokers to determine whether received assertions are trustworthy and interpretable.

With reference now to FIG. 10, a block diagram depicts a user, an e-commerce service provider, and an attribute information provider that interact in accordance with the federated architecture as described above in FIGS. 2A-4 while supporting attribute operations as described above with respect to FIGS. 5C-9B. User 1002 interacts with e-commerce service provider 1004 to request transactions, and e-commerce service provider 1004 obtains attribute information for user 1002 from attribute information provider 1006, e.g., as described in FIG. 6. User 1002 can also interact with attribute information provider 1006 as necessary in the manner described with respect to FIGS. 8A-9B to control various aspects of the operations at attribute information provider 1006. At the same time, attribute information provider 1006 acts as an issuing domain in accordance with FIG. 3A, and e-commerce service provider 1004 acts as a relying domain in accordance with FIG. 3B.

In particular, e-commerce service provider 1004 acts as a relying domain as shown in FIG. 3E in accordance with a pull model in which e-commerce service provider 1004 requests any required attribute assertions for a user from attribute information provider 1006, i.e. an issuing domain, while attempting to satisfy a resource request that was received at e-commerce service provider 1004 from the requesting user. Moreover, at step 616 in FIG. 6 in which the e-commerce service provider examines the attribute retrieval response message, if the point-of-contact server at the e-commerce service provider cannot interpret the attribute assertion that is provided by the attribute information provider, the e-commerce service provider would request assistance from its trust proxy. In this manner, a user can rely on one service, e.g., its home domain, for authentication and single-sign-on purposes, and at the same time, the user can rely on a different service, such as an attribute information provider, for management and control over the user's attribute information.

In a manner similar to that described above, the e-commerce service provider may retrieve the user attributes through the use of HTTP redirect messages via a user's browser or HTTP post message, or in a SOAP model, most likely a direct SOAP invocation between trust proxies with an attribute retrieval request in a SOAP message body.

The advantages of the present invention should be apparent in view of the detailed description of the invention that is provided above. Prior art solutions organize domain security services into hierarchies, which requires the domains to have rigid trust relationships and intrinsically compatible technologies. Other approaches impose a uniform format on the authentication assertion or do not allow for the transfer of authentication assertions, sometimes transferring an authenticated identity from which a local assertion is built.

Among the advantages of the present invention, the trust proxies allow the pre-existing security services in a given domain to establish trust relationships with other domains without having to subscribe to the same trust root or use the same trust-establishment technology. Hence, the federated architecture of the present invention provides a loose coupling of entities. A home domain manages authentication, and each domain manages authentication of only its own registered users. Each domain is free to accept, reject, or modify any other domain's statements about user identity and attributes. A relying domain relies on an issuing domain's (ultimately, a home domain's) assertions of identity and attributes, yet each domain can implement any authentication protocol, and the applications within a given domain do not need to be modified to implement a previously unsupported protocol in order for the domain to participate in the federation. The federation does not require a particular trust model; a set of entities can form a federation that conforms to the trust model that the participating entities may have already established. Assertion translations occur only at the trust proxies and/or the trust brokers; the federation architecture acts as a front-end infrastructure that can be implemented with minimal impact on an existing legacy system.

Federations allow users to seamlessly traverse different sites within a given federation in a single-sign-on fashion. Because of the trust relationships established between the federation participants, one participant is able to authenticate a user and then act as an issuing party for that user. Other federation partners become relying parties, whereby they rely on information that is provided about the user by the issuing party without the direct involvement of the user.

The present invention also allows a user to contract with one or more attribute information providers (AIPs). The user maintains a relationship with these attribute information providers and provides user attribute information that is stored and maintained by the attribute information providers. If the user employs more than one attribute information provider, the information that is stored may overlap, i.e. the attribute information providers do not necessarily store mutually exclusive sets of data items.

E-commerce service providers, such as online banks or online merchants, also maintain a relationship with an attribute information provider such that the e-commerce service provider can trust the user attribute information that is provided by the attribute information provider on behalf of the user. The user can visit any e-commerce service provider within a federated environment without having to establish an a priori relationship with that particular e-commerce service provider. As long as the user has a relationship with at least one attribute information provider, then the user will be able to have a simplified operation at an e-commerce service provider by not having to tediously provide all of the information that is required by the e-commerce service provider.

With the present invention, the user is not necessarily challenged for attribute information when attempting to access a protected resource at an e-commerce service provider under certain conditions. This allows some degree of free movement between domains that participate in the federated environment. The user gains some efficiency or productivity in not having to fulfill multiple informational requests, which can be barriers to free movement across Web sites.

Moreover, with the present invention, user attribute information can be permanently stored in a network in a location other than a user's client device. The user's attribute information is available to the entities in a federated environment even if the entities in the federated environment are not able to permanently store information on the user's client device, particularly when those entities are restricted from permanently storing the user's attribute information themselves, e.g., by legal restrictions or by contractual privacy policies. In addition, the present invention provides methods for maintaining user attribute information in a wireless environment in which the federated entities do not have the physical ability to store user attribute information on certain client devices, such as PDA's and mobile phones.

The present invention also supports a processing environment in which an attribute information provider may directly communicate with the user during a transaction prior to responding to the request from the e-commerce service provider. The attribute information provider can manage user attribute information in accordance with an attribute release policy containing restrictions that are determined by a user, by a service provider, by a federation, or by some other entity. Various processing options regarding the storage and management of user attribute information may be selectable by a user, after which an attribute information provider abides by the user's choices.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for managing user attribute information within a data processing system, the method comprising:
receiving from a user a request for a resource at a service provider;
determining a set of one or more attribute information providers that are associated with the user, wherein an attribute information provider is a service provider that maintains user attribute information for the user;
sending a request message to a first attribute information provider in the set of one or more attribute information providers in order to retrieve user attribute information for the user;
receiving a response message from the first attribute information provider at a point-of-contact server associated with the service provider;
determining that the response message comprises an attribute assertion; and
forwarding the attribute assertion for interpretation or validation from a point-of-contact server to a trust proxy associated with the service provider.

2. The method of claim 1 further comprising:
forwarding the attribute assertion to a trust broker from the trust proxy for interpretation or validation.

3. The method of claim 1 further comprising:
determining that the response message comprises a control flag from the first attribute information provider, wherein the control flag indicates a retrieval condition on subsequent requests from the service provider to attribute information providers while retrieving user attribute information for the user.

4. The method of claim 3 further comprising:
halting retrievals for user attribute information for the user in accordance with the control flag.

5. The method of claim 3 further comprising:
performing subsequent retrievals for user attribute information for the user in accordance with the control flag.

6. The method of claim 1 further comprising:
performing a user-specific operation for the resource based on retrieved user attribute information for the user.

7. A computer program product in a computer readable medium for use in a data processing system for managing user attribute information, the computer program product comprising:
means for receiving from a user a request for a resource at a service provider;
means for determining a set of one or more attribute information providers that are associated with the user, wherein an attribute information provider is a service provider that maintains user attribute information for the user;
means for sending a request message to a first attribute information provider in the set of one or more attribute information providers in order to retrieve user attribute information for the user;
means for receiving a response message from the first attribute information provider at a point-of-contact server associated with the service provider;
means for determining that the response message comprises an attribute assertion; and
means for forwarding the attribute assertion for interpretation or validation from a point-of-contact server to a trust proxy associated with the service provider.

8. The computer program product of claim 7 further comprising:
means for forwarding the attribute assertion to a trust broker from the trust proxy for interpretation or validation.

9. The computer program product of claim 7 further comprising:
means for determining that the response message comprises a control flag from the first attribute information provider, wherein the control flag indicates a retrieval condition on subsequent requests from the service provider to attribute information providers while retrieving user attribute information for the user.

10. The computer program product of claim 9 further comprising:
means for halting retrievals for user attribute information for the user in accordance with the control flag.

11. The computer program product of claim 9 further comprising:
means for performing subsequent retrievals for user attribute information for the user in accordance with the control flag.

12. The computer program product of claim 7 further comprising:
means for performing a user-specific operation for the resource based on retrieved user attribute information for the user.

13. An apparatus for managing user attribute information, the apparatus comprising:
means for receiving from a user a request for a resource at a service provider;
means for determining a set of one or more attribute information providers that are associated with the user, wherein an attribute information provider is a service provider that maintains user attribute information for the user;
means for sending a request message to a first attribute information provider in the set of one or more attribute information providers in order to retrieve user attribute information for the user;
means for receiving a response message from the first attribute information provider at a point-of-contact server associated with the service provider;
means for determining that the response message comprises an attribute assertion; and
means for forwarding the attribute assertion for interpretation or validation from a point-of-contact server to a trust proxy associated with the service provider.

14. The apparatus of claim 13 further comprising:
means for forwarding the attribute assertion to a trust broker from the trust proxy for interpretation or validation.

15. The apparatus of claim 13 further comprising:
means for determining that the response message comprises a control flag from the first attribute information provider, wherein the control flag indicates a retrieval condition on subsequent requests from the service provider to attribute information providers while retrieving user attribute information for the user.

16. The apparatus of claim 15 further comprising:
means for halting retrievals for user attribute information for the user in accordance with the control flag.

17. The apparatus of claim 15 further comprising:
means for performing subsequent retrievals for user attribute information for the user in accordance with the control flag.

18. The apparatus of claim 13 further comprising:
means for performing a user-specific operation for the resource based on retrieved user attribute information for the user.
